(19) United States
(12) Patent Application Publication
(10) Pub. No.: US 2025/0091887 A1
(43) Pub. Date: Mar. 20, 2025

(54) METHOD OF MAKING ZEOLITES OF BOG FRAMEWORK TYPE, ALUMINOSILICATE ZEOLITES OF BOG FRAMEWORK TYPE, AND USES THEREOF

(71) Applicant: EXXONMOBIL TECHNOLOGY AND ENGINEERING COMPANY, Spring, TX (US)

(72) Inventors: Trong D. Pham, Flemington, NJ (US); Hilda B. Vroman, Piscataway, NJ (US); Eugene A. Terefenko, Center Valley, PA (US)

(21) Appl. No.: 18/886,225

(22) Filed: Sep. 16, 2024

Related U.S. Application Data
(60) Provisional application No. 63/583,478, filed on Sep. 18, 2023.

(51) Int. Cl. C01B 39/48

(52) U.S. Cl. CPC C01B 39/48; C01P 2004/20; C01P 2004/61; C01P 2006/12; C01P 2006/14

(57) ABSTRACT

The present disclosure relates to a method of making zeolites of BOG framework type, in particular a direct synthesis method for the preparation of aluminosilicate zeolites of BOG framework type using 5-azaindolium cations as structure directing agents. The present disclosure also relates to small crystal forms of aluminosilicate zeolites of BOG framework type and uses thereof.

### CROSS REFERENCE TO RELATED APPLICATIONS

This Non-Provisional Patent application claims priority to U.S. Provisional Patent Application No. 63/583,478, filed Sep. 18, 2023, and titled “Method of making zeolites of BOG framework type, aluminosilicate zeolites of BOG framework type, and uses thereof”, the entire contents of which is incorporated herein by reference.

### TECHNICAL FIELD

The present disclosure relates to a method of making zeolites of BOG framework type, in particular a direct synthesis method for the preparation of aluminosilicate zeolites of BOG framework type using 5-azaindolium cations as structure directing agents. The present disclosure also relates to small crystal forms of aluminosilicate zeolites of BOG framework type and uses thereof.

### BACKGROUND OF THE INVENTION

Molecular sieve materials, both natural and synthetic, may be used as adsorbents and have catalytic properties for hydrocarbon conversion reactions. Certain molecular sieves, such as zeolites, AlPOs, and mesoporous materials, are ordered, porous crystalline materials having a definite crystalline structure as determined by X-ray diffraction (XRD). Certain molecular sieves are ordered and produce specific identifiable XRD patterns. Within certain molecular sieve materials there may be a large number of cavities, which may be interconnected by a number of channels or pores. These cavities and pores are uniform in size within a specific molecular sieve material. Because the dimensions of these pores are such as to accept for adsorption molecules of certain dimensions while rejecting those of larger dimensions, these materials have come to be known as “molecular sieves” and are utilized in a variety of industrial processes, e.g., cracking, hydrocracking, disproportionation, alkylation, oligomerization, and isomerization.

Molecular sieves that find application in catalysis and adsorption include any of the naturally occurring or synthetic crystalline molecular sieves. These zeolites and their isotypes are classified by the Structure Commission of the International Zeolite Association according to the rules of the IUPAC Commission on Zeolite Nomenclature. According to this classification, framework type zeolites and other crystalline microporous molecular sieves, for which a structure has been established, are assigned a three letter code and are described in the “Atlas of Zeolite Framework Types”, eds. Ch. Baerlocher, L. B. McCusker, and D. H. Olson, Elsevier, Sixth Edition, 2007, which is hereby incorporated by reference. These zeolites and their isotypes are also described in http://America.iza-structure.org/IZA-SC/ftc_table.php.

The idealized inorganic framework structure of zeolites is a framework of silicate in which all tetrahedral atoms are connected by oxygen atoms with the four next-nearest tetrahedral atoms. The term “silicate”, as used herein, refers to a substance containing at least silicon and oxygen atoms that are alternately bonded to each other (i.e., —O—Si—O—Si—), and optionally including other atoms within the inorganic framework structure, including atoms such as boron, aluminum, or other metals (e.g., transition metals, such as titanium, vanadium, or zinc). Atoms other than silicon and oxygen in the framework silicate occupy a portion of the lattice sites otherwise occupied by silicon atoms in an ‘all-silica’ framework silicate. Thus, the term “framework silicate” as used herein refers to an atomic lattice comprising any of a silicate, borosilicate, gallosilicate, ferrisilicate, aluminosilicate, titanosilicate, zincosilicate, vanadosilicate, or the like.

The structure of the framework silicate within a given zeolite determines the size of the pores or channels that are present therein. The pore or channel size may determine the types of processes for which a given zeolite is applicable. Currently, greater than 200 unique zeolite framework silicate structures are known and recognized by the Structure Commission of the International Zeolite Association, thereby defining a range of pore geometries and orientations.

The framework silicates of zeolites or molecular sieves are commonly characterized in terms of their ring size, wherein the ring size refers to the number of silicon atoms (or alternative atoms, such as those listed above) that are tetrahedrally coordinated with oxygen atoms in a loop to define a pore or channel within the interior of the zeolite. For example, an “8-ring” zeolite refers to a zeolite having pores or channels defined by 8 alternating tetrahedral atoms and 8 oxygen atoms in a loop. The pores or channels defined within a given zeolite may be symmetrical or asymmetrical depending upon various structural constrains that are present in the particular framework silicate.

Zeolites can be classified as having small, medium, large, and extra-large pore structures for pore windows delimited by 8, 10, 12, and more than 12 T-atoms, respectively. Extra-large pore zeolites (>12R) include, for example, AET (14R, e.g., ALPO-8), SFN (14R, e.g., SSZ-59), VFI (18R, e.g., VPI-5), CLO (20R, e.g., cloverite), and ITV (30R, e.g., ITQ-37) framework type zeolites. Extra-large pore zeolites generally have a free pore diameter of larger than about 0.8 nm. Large pore zeolites (12R) include, for example, LTL, MAZ, FAU, EMT, OFF, MTW, *BEA, MOR, BOG, and SFS framework type zeolites, e.g., mazzite, offretite, zeolite L, zeolite Y, zeolite X, omega, ZSM-2, ZSM-12, zeolite T, Beta, boggsite, and SSZ-56. Large pore zeolites generally have a free pore diameter of 0.6 to 0.8 nm. Medium (or intermediate) pore size zeolites (10R) include, for example, MFI, MEL, *MRE, EUO, MTT, MFS, AEL, AFO, HEU, FER, MWW, and TON framework type zeolites, e.g., ZSM-5, ZSM-11, ZSM-48, ZSM-22, ZSM-23, ZSM-35, MCM-22, silicalite-1, and silicalite-2. Medium pore size zeolites generally have a free pore diameter of 0.45 to 0.6 nm. Small pore size zeolites (8R) include, for example, CHA, RTH, ERI, KFI, LEV, and LTA framework type zeolites, e.g., ZK-4, SAPO-34, SAPO-35, ZK-14, SAPO-42, ZK-21, ZK-22, ZK-5, ZK-20, zeolite A, chabazite, and ALPO-17. Small pore size zeolites generally have a free pore diameter of 0.3 to 0.45 nm.

Synthesis of zeolite materials typically involves hydrothermal crystallization from a synthesis mixture comprising sources of all the elements present in the zeolite such as sources of silica but also of alumina etc. In many cases a structure directing agent (SDA) is also present. Structure directing agents are compounds which are believed to promote the formation of zeolites (or molecular sieves) and which are thought to act as templates around which certain zeolites (or molecular sieve structures) can form and which thereby promote the formation of the desired molecular sieve. Various compounds have been used as structure directing agents including various types of quaternary ammonium cations. Typically, zeolite (or molecular sieve) crystals form around structure directing agents with the structure directing agent occupying pores in the zeolite (or molecular sieve) once crystallization is complete. The “as-synthesized” (or “as-made”) zeolite (or molecular sieve) will therefore contain the structure directing agent in its pores so that, following crystallization, the “as-synthesized” zeolite (or molecular sieve) is usually subjected to a treatment step such as a calcination step to remove the structure directing agent.

Boggsite is a natural rare aluminosilicate mineral zeolite (Si/Al molar ratio close to 4.2) having a 3-D channel system formed by 12- and 10-ring intersecting channels (D. G. Howard et al., American Mineralogist, 75, 1200-1204 (1990); J. J. Pluth et al., American Mineralogist, 75, 501-507 (1990)). The unique pore architecture and aluminosilicate composition endow boggsite with potential applications in shape-selective acid catalysis. As detailed in R. Simancas et al., Science, 330, 1219-1222 (2010), synthetic boggsite (or BOG zeolite) was successfully crystallized as a germanoborosilicate (Si/Ge/B-ITQ-47) from a synthesis gel containing boron and germanium using a phosphazene organic structure directing agent (OSDA); Si/Ge/Al-ITQ-47 having a Si/Ge molar ratio of about 194 and a Si/Al molar ratio of about 26 was obtained by post-synthesis Al-exchange of Si/Ge/B-ITQ-47. Q. Huang et al., Chemical Science, 11, 12103-12108 (2020) discloses a seed-directed synthesis of Ge-free aluminosilicate BOG-type zeolite (Si/Al-BOG) with a moderate Si/Al molar ratio of 9.1 starting from the boron germanosilicate form of boggsite (Si/Ge/B-ITQ-47) as the seed and an aluminosilicate synthesis gel, in the absence of OSDA. The Si/Al-BOG crystallites were shown to contain some amorphous phase (about 9-18%) and exhibited bimodal morphology with a particle size distribution showing two peaks centered around 0.5-1.5 microns and 4.5-5.5 microns. More particularly, the Si/Al-BOG crystallites showed a randomly intergrown spindle-like morphology with a mixture of large crystallites (3-14 microns in length and about 1.5-2 microns in width) and small crystallites (0.5-2 microns in length and about 0.2-0.5 microns in width).

Despite these advances, there remains a need for more efficient methods for the synthesis of zeolites (or molecular sieves), such as zeolites of BOG framework type, in particular aluminosilicate zeolites of BOG framework type.

### SUMMARY

In a first aspect, the present disclosure relates to a method of making a zeolite of BOG framework type (e.g., BOG-type zeolite or BOG zeolite), in particular an aluminosilicate zeolite of BOG framework type, comprising the following steps:
(a) preparing a synthesis mixture comprising water, a source of silica, a source of alumina, a structure directing agent (Q), at least one of a source of hydroxide ions (OH) or of fluoride ions (F), and optionally a source of alkali and/or alkaline earth metal element (M), wherein the structure directing agent (Q) comprises at least one 5-azaindolium cation of Formula I, Formula II, Formula III, or Formula IV:

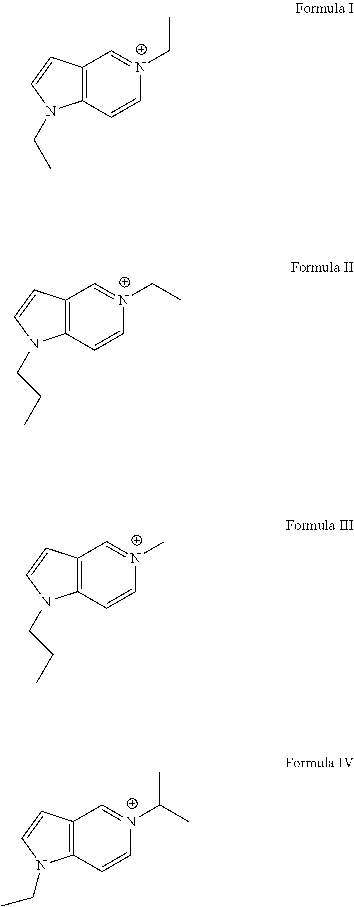

(b) heating said synthesis mixture under crystallization conditions including a temperature of from 100 to 200° C. for a time sufficient to form crystals of said molecular sieve;
(c) recovering at least a portion of the molecular sieve from step (b); and
(d) optionally treating the molecular sieve recovered in step (c) to remove at least part of the structure directing agent (Q).

In a second aspect, the present disclosure relates to an aluminosilicate zeolite of BOG framework type having at least one 5-azaindolium cation of Formula I, Formula II, Formula III, or Formula IV within its pore structure.

In a third aspect, the present disclosure relates to an aluminosilicate zeolite of BOG framework type having a Si/Al molar ratio of from 5 to 50, as determined by ICP, and an average maximal particle size of less than 2 micron, as determined by scanning electron microscopy (SEM).

In a fourth aspect, the present disclosure relates to an aluminosilicate zeolite of BOG framework type, in particular a zeolite according to the second or third aspect of the present disclosure, obtainable by the method disclosed herein.

In a fifth aspect, the present disclosure relates to a process of converting an organic compound to a conversion product, which comprises contacting the organic compound with the zeolite according to any of the second, third or fourth aspect of the present disclosure.

These and other features and attributes of the present disclosure and their advantageous applications and/or uses will be apparent from the detailed description which follows. It will of course be appreciated that features described in relation to one aspect of the present disclosure may be incorporated into other aspects of the present disclosure. In particular, any two or more of the features described in this specification, including in this summary section, can be combined to form combinations of features not specifically described herein.

### DESCRIPTION OF THE DRAWINGS

FIG. 1 shows the powder XRD pattern of the as-synthesized product of Example 2.

FIG. 2 shows the powder XRD pattern of the calcined product of Example 2.

FIG. 3 shows SEM images of the as-synthesized product of Example 2.

FIG. 4 shows the powder XRD pattern of the as-synthesized product of Example 3.

FIG. 5 shows a SEM image of the as-synthesized product of Example 3.

FIG. 6 shows the powder XRD pattern of the as-synthesized product of Example 9.

FIG. 7 shows the powder XRD pattern of the calcined product of Example 9.

FIG. 8 shows the powder XRD pattern of the as-synthesized product of Example 10.

FIG. 9 shows SEM images of the as-synthesized product of Example 10.

### DETAILED DESCRIPTION

The present disclosure relates to methods of making zeolites of BOG framework type (e.g., BOG-type zeolites or BOG zeolites), in particular aluminosilicate zeolites of BOG framework type, small crystal forms of such materials, and uses thereof. Said zeolite materials may be designated as EMM-76 zeolites, or EMM-76 materials.

In a first aspect, the present disclosure relates to a method of making a zeolite of BOG framework type comprising the following steps:
(a) preparing a synthesis mixture comprising water, a source of silica, a source of alumina, a structure directing agent (Q), at least one of a source of hydroxide ions (OH) or of fluoride ions (F), and optionally a source of alkali and/or alkaline earth metal element (M), wherein the structure directing agent (Q) comprises at least one 5-azaindolium cation of Formula I, Formula II, Formula III, or Formula IV:

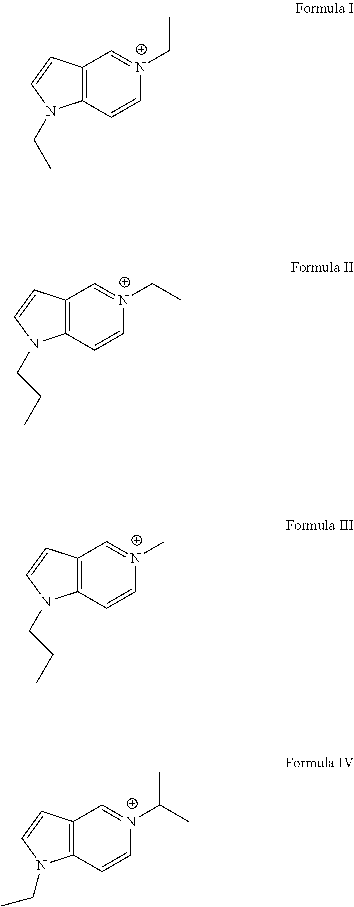

(b) heating said synthesis mixture under crystallization conditions including a temperature of from 100 to 200° C. for a time sufficient to form crystals of said zeolite;
(c) recovering at least a portion of the zeolite from step (b); and
(d) optionally treating the zeolite recovered in step (c) to remove at least part of the structure directing agent (Q).

The structure directing agent (Q) comprises at least one of a 1,5-diethyl-5-azaindolium cation of Formula I, of a 5-ethyl-1-propyl-5-azaindolium cation of Formula II, of a 5-methyl-1-propyl-5-azaindolium cation of Formula III, or of a 1-ethyl-5-isopropyl-5-azaindolium cation of Formula IV, in particular at least one 1,5-diethyl-5-azaindolium cation of Formula I. The structure directing agent (Q) may be present in any suitable form, for example as a halide, such as a fluoride, a chloride, an iodide or a bromide, as a hydroxide or as a nitrate, for instance in its hydroxide form. The structure directing agent (Q) may be present in the synthesis mixture in a Q/Si molar ratio of from 0.01 to 1.0, such as from 0.05 to 1.0, or 0.1 to 0.8, or 0.15 to 0.7.

The synthesis mixture comprises at least one source of silica. Suitable sources of silica (e.g., silicon oxide sources) for use in the method include silicates, e.g., tetraalkyl orthosilicates such as tetramethylorthosilicate (TMOS) and tetraethylorthosilicate (TEOS), fumed silica such as Acrosil® (available from Evonik), Cabosperse® (available from Cabot) and CabO—O-Sil® (available from DMS), precipitated silica such as Ultrasil® and Sipernat® 340 (available from Evonik) or Hi-Sil®, alkali metal silicates such as potassium silicate and sodium silicate, aqueous colloidal suspensions of silica, for example, that sold by Grace under the tradename Ludox® or that sold by Evonik under the tradename Aerodisp®; preferably silicates, fumed silica, colloidal silica, precipitated silica, and alkali metal silicates.

The synthesis mixture comprises at least one source of alumina. Suitable sources of alumina (e.g., aluminum oxide) for use in the method include aluminum hydroxide, aluminum salts, especially water-soluble salts, such as aluminum sulfate, aluminum nitrate, alkali metal aluminates such as sodium or potassium aluminate, and aluminum alkoxides such as aluminum isopropoxide, as well as hydrated aluminum oxides, such as bochmite, gibbsite, and pseudobochmite, and mixtures thereof. Other aluminum sources include, but are not limited to, other water-soluble aluminum salts, or aluminum metal, such as aluminum in the form of chips. Especially suitable sources of alumina are aluminum hydroxide and water-soluble salts, such as aluminum sulfate, aluminum nitrate, and alkali metal aluminates such as sodium aluminate and potassium aluminate.

Alternatively or in addition to previously mentioned sources of Si and Al, sources containing both Si and Al elements can also be used. Examples of suitable sources containing both Si and Al elements include amorphous silica-alumina gels or dried silica alumina powders, silica aluminas, clays, such as kaolin, metakaolin, and zeolites, in particular aluminosilicates such as synthetic faujasite and ultrastable faujasite, for instance Y-Type Zeolite, Ultrastable Y (USY), beta or other large to medium pore molecular sieves or zeolites. Aluminosilicates such as synthetic faujasite and ultrastable faujasite are especially suitable sources of Si and Al.

The synthesis mixture may have a Si/Al molar ratio of from 5 to 50, such as 6 or 7 to 40, for instance 8 or 10 to 35, e.g., 6, 8, 10, 15, 20 or 30.

The synthesis mixture comprises at least one of a source of hydroxide ions (OH) or of fluoride ions (F). Suitable synthesis mixture compositions, in terms of molar ratios, are illustrated in the table below, at least one of the OH/Si or F/Si molar ratio being different than 0:

| Molar ratios | Typical range | Preferred range | | More preferred range | |
|---|---|---|---|---|---|
| Si/Al | 5-50 | 7-40 | | 8-35 | |
| Q/Si | 0.01-1.0 | 0.05-1.0 | | 0.1-0.8 | |
| F/Si | 0-2.0 | 0.1-1.5 | (if present) | 0.3-1.0 | (if present) |
| OH/Si | 0-1.5 | 0.1-1.0 | (if present) | 0.15-0.8 | (if present) |
| M/Si | 0-1.0 | 0.05-0.5 | (if present) | 0.08-0.2 | (if present) |

| | | | |
|---|---|---|---|
| H₂O/Si | 1-100 | 3-80 | 3-50 |

In a first embodiment, the synthesis mixture comprises at least one source of hydroxide ions (OH) (“synthesis in hydroxide media”). For example, hydroxide ions can be present as a counter ion of the structure directing agent (Q) or by the use of aluminum hydroxide or sodium aluminate as a source of Al. Suitable sources of hydroxide ions can also be selected from the group consisting of alkali metal hydroxides, alkaline earth metal hydroxides, ammonium hydroxide, and mixtures thereof; such as from sodium hydroxide, potassium hydroxide, lithium hydroxide, rubidium hydroxide, cesium hydroxide, calcium hydroxide, magnesium hydroxide, ammonium hydroxide, and mixtures thereof; more often sodium hydroxide, potassium hydroxide, cesium hydroxide, ammonium hydroxide, and mixtures thereof; most often cesium hydroxide and/or potassium hydroxide, e.g., potassium hydroxide. In this first embodiment, the hydroxide ions source may be present in the synthesis mixture in a OH/Si molar ratio of from 0.01 to 1.5, such as from 0.05 or 0.1 to 1.0, for instance from 0.15 to 0.8, or 0.2 to 0.7 or to 0.6, e.g., 0.3, 0.4 or 0.5.

In this first embodiment, the synthesis mixture may comprise the structure directing agent (Q) in a Q/Si molar ratio of from 0.01 to 1.0, such as from 0.05 to 0.8, or 0.1 to 0.7, advantageously 0.1 to 0.5, or 0.1 to 0.4, e.g., 0.1, 0.15 or 0.2.

In this first embodiment, the synthesis mixture may optionally comprise one or more sources of alkali or alkaline earth metal cation (M). If present, M is preferably selected from the group consisting of sodium, potassium, lithium, rubidium, cesium, calcium, magnesium, strontium, barium, and mixtures thereof, preferably sodium, potassium, cesium, and mixtures thereof, more preferably cesium and/or potassium, most preferably potassium. The sodium source, when present, may be sodium hydroxide, sodium aluminate, sodium silicate, or sodium salts such as NaCl, NaBr or sodium nitrate. The potassium source, when present, may be potassium hydroxide, potassium aluminate, potassium silicate, a potassium salt such as KCl or KBr or potassium nitrate. The lithium source, when present, may be lithium hydroxide or lithium salts such as LiCl, LiBr, LiI, lithium nitrate, or lithium sulfate. The rubidium source, when present, may be rubidium hydroxide or rubidium salts such as RbCl, RbBr, RbI, or rubidium nitrate. The cesium source, when present, may be cesium hydroxide. The calcium source, when present, may be calcium hydroxide. The magnesium source, when present, may be magnesium hydroxide. The strontium source, when present, may be strontium hydroxide. The barium source, when present, may be barium hydroxide. The alkali or alkaline earth metal cation M may also be present in the one or more sources of alumina, such as sodium aluminate or potassium aluminate and/or in the one or more sources of silica, such as potassium silicate and/or sodium silicate. The source of alkali or alkaline earth metal cation (M) is advantageously soluble in water. The synthesis mixture may comprise the alkali or alkaline earth metal cation (M) source in a M/Si molar ratio of from 0 or 0.01 to 1.0, such as (if present) from 0.05 to 0.5, for instance from 0.08 or from 0.1 to less than 0.3, or less than 0.25, such as to 0.2 or less than 0.2, e.g., 0.1 or 0.15. Preferably, the synthesis mixture comprises one or more sources of alkali or alkaline earth metal cation (M). Alternatively, the synthesis mixture may be substantially free from alkali or alkaline earth metal cation (M).

In this first embodiment, the synthesis mixture is preferably substantially free of fluoride ions (F). This means that no source of fluoride ions is added to the synthesis mixture in any substantial amount, e.g., the synthesis mixture has a F/Si molar ratio of less than 0.05, in particular less than 0.01 or even less than 0.005, such as 0. Said fluoride ions (F), if present, may originate from any compound capable of releasing fluoride ions in the zeolite synthesis mixture, such as hydrogen fluoride (HF); salts containing one or several fluoride ions, such as metal fluoride, preferably where the metal is an alkali or alkaline earth metal such as sodium, potassium, calcium, magnesium, strontium or barium, or a metal such as aluminum (AlF₃, Al₂F₆) or tin (SnF₂); ammonium fluoride (NH₄F); and ammonium bifluoride (NH₄HF₂). Small amounts of fluoride ions (F) may also be present as impurities, for instance in the optional source of alkali or alkaline earth metal cation (M).

In this first embodiment, the synthesis mixture may optionally contain at least one source of halide ions (W), different from fluoride ions, which may be selected from the group consisting of chloride, bromide or iodide. The source of halide ions (W) may be any compound capable of releasing halide ions in the zeolite synthesis mixture. For instance, halide ions can be present as a counter ion of the structure directing agent (Q). Non-limiting examples of sources of halide ions include hydrogen chloride, ammonium chloride, hydrogen bromide, ammonium bromide, hydrogen iodide, and ammonium iodide; salts containing one or several halide ions, such as metal halides, preferably where the metal is an alkali or alkaline earth metal such as sodium, potassium, calcium, magnesium, strontium or barium; or tetraalkylammonium halides such as tetramethylammonium halides or tetraethylammonium halides. Small amounts of halide ions (W) may also be present as impurities, for instance in the optional source of alkali or alkaline earth metal cation (M). The halide ions (W) may be present in a W/Si molar ratio of 0 to 0.2, such as 0 to 0.1, for instance less than 0.1 or even 0. Alternatively, the synthesis mixture may be substantially free from halide ions (W).

In this first embodiment, the synthesis mixture may comprise water in a H₂O/Si molar ratio of from 1 to 100, such as 5 to 80 or 10 to 70, for instance 15 to 50, or 20 to 40. Depending on the nature of the components in the base mixture, the amount of solvent (e.g., water from the hydroxide solution, and optionally methanol and ethanol from the hydrolysis of silica sources) of the base mixture may be removed such that a desired solvent to Si molar ratio is achieved for the synthesis mixture. Suitable methods for reducing the solvent content may include evaporation under a static or flowing atmosphere such as ambient air, dry nitrogen, dry air, or by spray drying or freeze drying. Water may also be added to the resulting mixture to achieve the desired H₂O/Si molar ratio when too much water is removed during the solvent removal process. In some examples, water removal is not necessary when the preparation have sufficient H₂O/Si molar ratio.

In a second embodiment, the synthesis mixture comprises at least one source of fluoride ions (F) (so-called “synthesis in fluoride media”). The source of fluoride ions (F) may be any compound capable of releasing fluoride ions in the zeolite synthesis mixture. For instance, fluoride ions can be present as a counter ion of the structure directing agent (Q). Non-limiting examples of sources of fluoride ions (F) include hydrogen fluoride (HF); salts containing one or several fluoride ions, such as metal fluoride, preferably where the metal is an alkali or alkaline earth metal such as sodium, potassium, calcium, magnesium, strontium or barium, or a metal such as aluminum (AlF₃, Al₂F₆) or tin (SnF₂); ammonium fluoride (NH₄F); and ammonium bifluoride (NH₄HF₂). Especially convenient sources of fluoride ions are HF, NH₄F, and NH₄HF₂, in particular HF. Small amounts of fluoride ions (F) may also be present as impurities, for instance in the optional source of alkali or alkaline earth metal cation (M). In this second embodiment, the fluoride ions (F) may be present in the synthesis mixture in a F/Si molar ratio of 0.05 to 2.0, for instance 0.1 to 1.5, such as 0.15 or 0.2 or 0.3 to 1.0 or 0.8, e.g., 0.5 or 1.0.

In this second embodiment, the synthesis mixture may comprise the structure directing agent (Q) in a Q/Si molar ratio of from 0.01 to 1.0, such as from 0.05 or from 0.1 to 1.0, or from 0.2 to 0.8, advantageously from 0.2 or 0.3 to 0.7 or 0.6, e.g., 0.4 or 0.5.

In this second embodiment, the synthesis mixture may optionally comprise at least one source of hydroxide ions (OH). For example, hydroxide ions can be present as a counter ion of the structure directing agent (Q) or by the use of aluminum hydroxide or sodium aluminate as a source of Al. Suitable sources of hydroxide ions can also be selected from the group consisting of alkali metal hydroxides, alkaline earth metal hydroxides, ammonium hydroxide, and mixtures thereof; such as from sodium hydroxide, potassium hydroxide, lithium hydroxide, rubidium hydroxide, cesium hydroxide, calcium hydroxide, magnesium hydroxide, ammonium hydroxide, and mixtures thereof; more often sodium hydroxide, potassium hydroxide, cesium hydroxide, ammonium hydroxide, and mixtures thereof; most often cesium hydroxide and/or potassium hydroxide, e.g., potassium hydroxide. The synthesis mixture may comprise the hydroxide ions source in an OH/Si molar ratio of from 0 to 1.5, such as (if present) from 0.05 or 0.1 to 1.0, for instance from 0.15 to 0.8, or 0.2 to 0.7 or to 0.6, e.g., 0.3, 0.4 or 0.5. Alternatively, the synthesis mixture may be substantially free from a hydroxide source.

In this second embodiment, the synthesis mixture may optionally comprise one or more sources of alkali or alkaline earth metal cation (M). If present, M is preferably selected from the group consisting of sodium, potassium, lithium, rubidium, cesium, calcium, magnesium, strontium, barium, and mixtures thereof, preferably sodium, potassium, cesium, and mixtures thereof, more preferably cesium and/or potassium, most preferably potassium. The sodium source, when present, may be sodium hydroxide, sodium aluminate, sodium silicate, or sodium salts such as NaCl, NaBr or sodium nitrate. The potassium source, when present, may be potassium hydroxide, potassium aluminate, potassium silicate, a potassium salt such as KCl or KBr or potassium nitrate. The lithium source, when present, may be lithium hydroxide or lithium salts such as LiCl, LiBr, LiI, lithium nitrate, or lithium sulfate. The rubidium source, when present, may be rubidium hydroxide or rubidium salts such as RbCl, RbBr, RbI, or rubidium nitrate. The cesium source, when present, may be cesium hydroxide. The calcium source, when present, may be calcium hydroxide. The magnesium source, when present, may be magnesium hydroxide. The strontium source, when present, may be strontium hydroxide. The barium source, when present, may be barium hydroxide. The alkali or alkaline earth metal cation M may also be present in the one or more sources of alumina, such as sodium aluminate or potassium aluminate and/or in the one or more sources of silica, such as potassium silicate and/or sodium silicate. The source of alkali or alkaline earth metal cation (M) is advantageously soluble in water. The synthesis mixture may comprise the alkali or alkaline earth metal cation (M) source in a M/Si molar ratio of 0 to 1.0, such as (if present) 0.01 to 0.5, for instance 0.01 to 0.2, e.g., 0 or 0.01 to 0.1, advantageously less than 0.1, such as at most 0.05. Preferably, the synthesis mixture may be substantially free from alkali or alkaline earth metal cation (M). This means that no source of alkali or alkaline earth metal cation (M) is added to the synthesis mixture in any substantial amount, e.g., the synthesis mixture has a M/Si molar ratio of less than 0.05, in particular less than 0.01 or even less than 0.005, such as 0.

In this second embodiment, the synthesis mixture may optionally contain at least one source of halide ions (W), different from fluoride ions, which may be selected from the group consisting of chloride, bromide, or iodide. The source of halide ions (W) may be any compound capable of releasing halide ions in the zeolite synthesis mixture. For instance, halide ions can be present as a counter ion of the structure directing agent (Q). Non-limiting examples of sources of halide ions include hydrogen chloride, ammonium chloride, hydrogen bromide, ammonium bromide, hydrogen iodide, and ammonium iodide; salts containing one or several halide ions, such as metal halides, preferably where the metal is an alkali or alkaline earth metal such as sodium, potassium, calcium, magnesium, strontium, or barium; or tetraalkylammonium halides such as tetramethylammonium halides or tetraethylammonium halides. Small amounts of halide ions (W) may also be present as impurities, for instance in the optional source of alkali or alkaline earth metal cation (M). The halide ions (W) may be present in a W/Si molar ratio of 0 to 0.2, such as 0 to 0.1, for instance less than 0.1 or even 0. Alternatively, the synthesis mixture may be substantially free from halide ions (W).

In this second embodiment, the synthesis mixture typically comprises water in a H₂O/Si molar ratio of from 1 to 50, such as 2 to 40 or 3 to 30, for instance 3 to 15, e.g., 3, 5 or 10. Depending on the nature of the components in the base mixture, the amount of solvent (e.g., water from the hydroxide solution, and optionally methanol and ethanol from the hydrolysis of silica sources) of the base mixture may be removed such that a desired solvent to Si molar ratio is achieved for the synthesis mixture. Suitable methods for reducing the solvent content may include evaporation under a static or flowing atmosphere such as ambient air, dry nitrogen, dry air, or by spray drying or freeze drying. Water may also be added to the resulting mixture to achieve the desired H₂O/Si molar ratio when too much water is removed during the solvent removal process. In some examples, water removal is not necessary when the preparation have sufficient H₂O/Si molar ratio.

The synthesis of the present disclosure, whether according to the first or second embodiment, may be performed with or without added nucleating seeds, preferably in the presence of nucleating seeds. If nucleating seeds are added to the synthesis mixture, the seeds may be of the same or of a different structure than the zeolite of the present disclosure, preferably BOG-type zeolites or EMM-76 zeolite obtained from a previous synthesis, and may suitably present in an amount from about 0.01 ppm by weight to about 10,000 ppm by weight, based on the synthesis mixture, such as from about 100 ppm by weight to about 5,000 ppm by weight of the synthesis mixture.

Carbon in the form of CH₂ may be present in the various sources of components used to prepare the zeolite of the present disclosure, e.g., silica source or alumina source, and incorporated into the resulting zeolite framework as bridging atoms. Nitrogen atoms may be incorporated into the framework of the zeolite material as bridging atoms after the SDA has been removed.

In one or more aspects, the synthesis mixture after solvent adjustment (e.g., where the desired water to silica ratio is achieved) may be mixed by a mechanical process such as stirring or high shear blending to assure suitable homogenization of the base mixture, for example, using dual asymmetric centrifugal mixing (e.g., a FlackTek speedmixer) with a mixing speed of 1000 to 3000 rpm (e.g., 2000 rpm).

The synthesis mixture is then subject to crystallization conditions suitable for the zeolite material to form. Crystallization of the zeolite may be carried out under static or stirred conditions in a suitable reactor vessel, such as for example Teflon® lined or stainless-steel autoclaves placed in a convection oven maintained at an appropriate temperature.

The crystallization in step (b) of the method is typically carried out at a temperature of 100° C. to 200° C., such as 120° C. to 180° C., preferably 150° C. to 170° C., e.g., 160° C., for a time sufficient for crystallization to occur at the temperature used. For instance, at higher temperatures, the crystallization time may be reduced. For instance, the crystallization conditions in step (b) of the method may include heating for a period of from 1 to 100 days, such as from 1 to 50 days, for example from 1 to 30 days, e.g., at least 1 or at least 5 days up to 30 or 20 days. In a particularly preferred embodiment, in hydroxide media, the crystallization conditions in step (b) may include heating for a particularly short period of time, such as from 1 to less than 20 days, in particular from 2 to less than 14 days, for example from 3 to 12 days, e.g., for about 7, 8, 9 or 10 days. The crystallization time can be established by methods known in the art such as by sampling the synthesis mixture at various times and determining the yield and X-ray crystallinity of precipitated solid. Unless indicated otherwise herein, the temperature measured is the temperature of the surrounding environment of the material being heated, for example the temperature of the atmosphere in which the material is heated.

Typically, the zeolite is formed in solution and can be recovered by standard means, such as by centrifugation or filtration. The separated zeolite can also be washed, recovered by centrifugation or filtration and dried.

The zeolite of the present disclosure, when employed either as an adsorbent or as a catalyst in an organic compound conversion process may be dehydrated (e.g., dried) at least partially. This can be done by heating to a temperature in the range of 80° C. to 500° C., such as 90° C. to 370° C. in an atmosphere such as air, nitrogen, etc., and at atmospheric, sub-atmospheric or super-atmospheric pressures for between 30 minutes and 48 hours. Dehydration may also be performed at room temperature merely by placing the zeolite in a vacuum, but a longer time is required to obtain a sufficient amount of dehydration.

As a result of the crystallization process, the recovered product contains within its pores at least a portion of the structure directing agent used in the synthesis. The as-synthesized zeolite recovered from step (c) may thus be subjected to thermal treatment or other treatment to remove part or all of the SDA incorporated into its pores during the synthesis. Thermal treatment (e.g., calcination) of the as-synthesized zeolite typically exposes the materials to high temperatures sufficient to remove part or all of the SDA, in an atmosphere selected from air, nitrogen, ozone or a mixture thereof in a furnace. While sub-atmospheric pressure may be employed for the thermal treatment, atmospheric pressure is desired for reasons of convenience. The thermal treatment may be performed at a temperature up to 925° C. e.g., 300° C. to 700° C. or 400 to 600° C. The temperature measured is the temperature of the surrounding environment of the sample. The thermal treatment (e.g., calcination) may be carried out in a box furnace in dry air, which has been exposed to a drying tube containing drying agents that remove water from the air. The material is usually calcined for at least 1 minute and generally no longer than 1 or at most a few days. The heating may first be carried out under a nitrogen atmosphere and then the atmosphere may be switched to air and/or ozone.

The zeolite material may also be subjected to an ion-exchange treatment, for example, with aqueous ammonium salts, such as ammonium nitrates, ammonium chlorides, and ammonium acetates, in order to remove remaining alkali metal cations and/or alkaline earth metal cations, if present in the synthesis mixture, and to replace them with protons thereby producing the acid form of the zeolite. To the extent desired, the original cations of the as-synthesized material, such as alkali metal cations, can be replaced by ion exchange with other cations. Preferred replacing cations can include hydrogen ions, hydrogen precursor, e.g., ammonium ions and mixtures thereof. The ion exchange step may take place after the as-made zeolite is dried. The ion-exchange step may take place either before or after a calcination step.

The zeolite material may also be subjected to other treatments such as steaming and/or washing with solvent. Such treatments are well-known to the skilled person and are carried out in order to modify the properties of the zeolite as desired.

In a preferred embodiment of the present disclosure, the zeolite of BOG framework type is an aluminosilicate. This material may be designated as EMM-76 zeolite or EMM-76 material.

The method of the present disclosure is especially advantageous in that it allows the direct preparation of aluminosilicate zeolites of BOG framework type, in particular of substantially pure aluminosilicate zeolites of BOG framework type, without the need for first preparing germanium- and/or boron-containing materials. In addition, the method of the present disclosure allows for the preparation of aluminosilicate zeolites of BOG framework type with a wide variety of Si/Al molar ratios (e.g., from 5 to 50) using a simple and scalable organic structure direct agent (Q), in both hydroxide and fluoride media. A further advantage is shorter crystallization times in hydroxide media, as compared to the prior art. This material is further characterized by a small particle size and interesting texture properties, such as high surface area and pore volume.

In a second aspect, the present disclosure relates to an aluminosilicate zeolite of BOG framework type, in particular EMM-76, having at least one 5-azaindolium cation of Formula I, Formula II, Formula III, or Formula IV within its pore structure. Said zeolite may be represented by the molecular formula of Formula V:

(q)Q: (m)Al₂O₃:SiO₂ (Formula V),

wherein 0<q≤1.0, 0.01<m≤0.1, and Q is at least one 5-azaindolium cation of Formula I, Formula II, Formula III, or Formula IV. The oxygen atoms in Formula V may be replaced by carbon atoms (e.g., in the form of CH₂), which can come from sources of the components used to prepare the as-made zeolite. The oxygen atoms in Formula V can also be replaced by nitrogen atoms, e.g., after the SDA has been removed. Formula V can represent the framework of a typical zeolite material having structure directing agent (Q) within its pore structure and is not meant to be the sole representation of such material. The zeolite may contain impurities which are not accounted for in Formula V. Further, Formula V does not include the protons and charge compensating ions that may be present in the zeolite material.

The variable m represents the molar ratio relationship of Al₂O₃ to SiO₂ in Formula V. For example, when m is 0.01, the molar ratio of SiO₂ to Al₂O₃ is 100 and the Si/Al molar ratio is 50. m may vary from 0.01 to 0.1, such as from 0.0125 to 0.08, e.g. from 0.015 to 0.05. The molar ratio of Si to Al may be 5 to 50, in particular 7 to 40, such as 8 to 35, for instance 10 to 35.

The variable q represents the molar relationship of Q to SiO₂ in Formula V. For example, when q is 0.1, the Q/Si molar ratio is 0.1. The molar ratio of Q to SiO₂ may be from 0 to 1.0, such as from 0.05 to 0.7 or 0.6, e.g., 0.1 to 0.5.

In a third aspect, the present disclosure relates to an aluminosilicate zeolite of BOG framework type, in particular EMM-76, having a Si/Al molar ratio of from 5 to 50, in particular a Si/Al molar ratio of from 6 or 7 to 40, such as 8 or 10 to 35, e.g., 6, 8, 10, 15, 20 or 30, as determined by inductively coupled plasma (ICP). Said EMM-76 material, in its as-made form, may be optionally represented by the molecular formula of Formula V as defined above. Said EMM-76 material, in its calcined form (e.g., where at least part of the SDA has been removed via thermal treatment or other treatment), may be optionally represented by the molecular formula of Formula VI:

(m)Al₂O₃:SiO₂ (Formula VI),

wherein 0.01<m≤0.1. The oxygen atoms in Formula VI may be replaced by carbon atoms (e.g., in the form of CH₂), which can come from sources of the components used to prepare the as-made zeolite. The oxygen atoms in Formula VI can also be replaced by nitrogen atoms, e.g., after the SDA has been removed. Formula VI can represent the framework of a typical zeolite as defined in the present disclosure, in its calcined form, and is not meant to be the sole representation of said zeolite. Said zeolite, in its calcined form, may contain SDA and/or impurities after appropriate treatments to remove the SDA and impurities, which are not accounted for in Formula VI. Further, Formula VI does not include the protons and charge compensating ions that may be present in the calcined zeolite. The variable m represents the molar ratio relationship of Al₂O₃ to SiO₂ in Formula VI. The values for variable m in Formula VI are the same as those described herein for Formula V.

The zeolite of the present disclosure, in particular the aluminosilicate zeolite of the second or third aspect of the present disclosure, advantageously has a small particle size (or crystal size or crystallite size). More particularly, at least a portion of the zeolite of the present disclosure (whether in as-synthesized or calcined form) may have a maximal particle size, defined as the maximal dimension of the particle, of less than 2 microns, in particular of less than 1 micron, more particularly of less than 0.75 micron, most particularly of less than 0.5 micron, such as from 50 or 75 to less than 500 nm, e.g., from 100 to 200 nm or from 200 to 300 nm or from 300 to 500 nm. By “at least a portion” is meant at least about 50% of the zeolite particles (or crystals), such as at least 60%, at least 75%, or at least 85%. The maximal dimension of the particles as well as the percentage (as vol %) of particles having said maximal dimension can be determined by image analysis, for example, of scanning electron microscopy (SEM) micrographs, e.g., using ImageJ software. In a further or another embodiment, the zeolite of the present disclosure (whether in as-synthesized or calcined form) may have an average maximal particle size of less than 2 microns, in particular of less than 1 micron, more particularly of less than 0.75 micron, most particularly of less than 0.5 micron, such as from 50 or 75 to less than 500 nm, for instance from 100 to 400 nm, e.g., from 100 to 200 nm or from 200 to 300 nm or from 300 to 500 nm. The average maximal particle size can be defined as the average (or arithmetic mean) of the maximal dimension of particles measured from randomly selected SEM micrographs from which were selected at least one hundred particles.

In yet another or further embodiment, at least a portion of the zeolite of the present disclosure (whether in as-synthesized or calcined form), in particular of the aluminosilicate zeolite of the second or third aspect of the present disclosure, can have a plate-like morphology. By “at least a portion” of the zeolite can have a plate-like morphology is meant at least about 50% of the zeolite crystals can have a plate-like morphology, such as at least 60%, at least 75%, or at least 85%. By “plate-like morphology” is meant crystals that are substantially in the form of platelets, for instance of discs or rectangular plates, having first and second major dimensions that can be referred to as the length (l) and the breadth (b) of the platelet (i.e., the longest dimension of the biggest face of the platelet and the dimension of said biggest face measured at the middle and perpendicular to said longest dimension) and a minor third dimension that can be referred to as the thickness (t) of the platelet (i.e., smallest dimension measured at the middle of the longest dimension, perpendicular to said biggest face). The morphology as well as the percentage (as vol %) of crystals having said morphology can be determined by image analysis, for example, of scanning electron microscopy (SEM) micrographs, e.g., using ImageJ software.

The zeolite crystals having a plate-like morphology may for instance have a length to breadth ratio (l/b) of from 1 to 10, such as from 1 to 8, or from 1 to 6, e.g., from 1 to 3, and a length to thickness ratio (l/t) of 5 or more, such as from 5 to 50, or from 10 to 20. The breadth to thickness ratio (b/t) may vary accordingly. In more specific embodiments, the zeolite crystals having a plate-like morphology may have a length (l) of from 50 nm to less than 2 μm, such as from 50 nm or from 75 nm to less than 1 μm, or to less than 750 nm, or to less than 500 nm, for instance from 100 to 500 nm, e.g., from 50 to 500 nm, or from 100 to 200 nm, or from 200 nm to 500 nm.

The zeolite of the present disclosure, in particular the aluminosilicate zeolite of the second or third aspect of the present disclosure, advantageously has, in its calcined form, a total BET surface area of 300 to 1000 m²/g, for instance from 610 to 800 m²/g, e.g., 715 m²/g; a micropore surface area of 300 to 1000 m²/g, for instance from 600 to 800 m²/g, e.g., 652 m²/g; an external surface area of 10 to 150 m²/g, such as from 30 to 100 m²/g, e.g., 63 m²/g; and/or a micropore volume of 0.1 to 0.3 cc/g, for instance more than 0.22 to 0.3 cc/g, in particular from 0.23 to 0.28, e.g., 0.25 cc/g.

The zeolite of the second and third aspects of the present disclosure may suitably be obtained by the method of the first aspect. In a fourth aspect, the present disclosure therefore relates to an aluminosilicate zeolite of BOG framework type, in particular EMM-76, obtainable by (or obtained by) the method of the first aspect of the present disclosure.

The zeolite of the present disclosure is of BOG framework type. In particular, the framework structure of the zeolite of the present disclosure may be identified as possessing a three-dimensional (3-D) channel system of intersecting 10-ring (5.5±0.20 Å by 5.8±0.20 Å) and 12-ring (7.0±0.20 Å by 7.0±0.20 Å) pores (12MR×10MR×10MR). The 12-ring channel along a direction dissects with 10-ring window into left and right channels along b direction. Correspondingly, each 10-ring channel is connected to left and right 12-ring channels to yield a 3-D access.

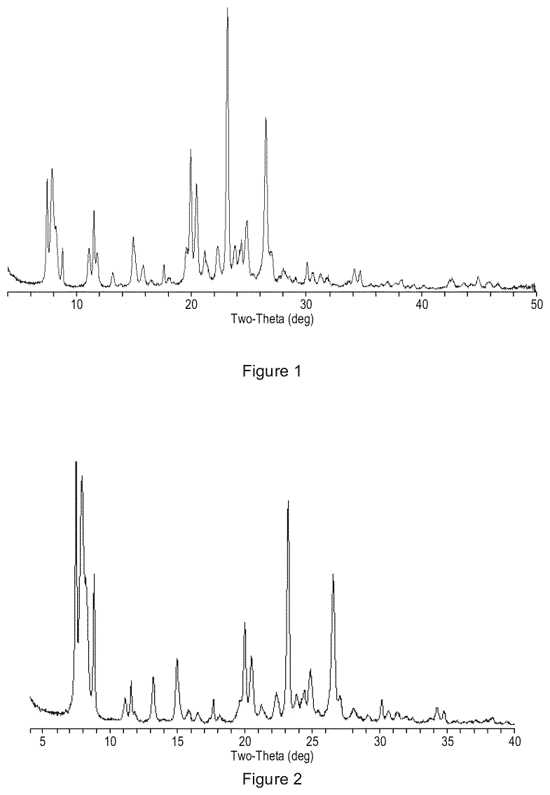

The zeolite of the present disclosure may have, in its as-synthesized form (e.g., where the SDA has not been removed) and/or calcined form (e.g., where at least part of the SDA has been removed via thermal treatment or other treatment), X-ray diffraction (XRD) patterns similar to those of boggsite or ITQ-47 (as disclosed in, e.g., FIG. 1 of Q. Huang et al., Chemical Science, 11, 12103-12108 (2020)). More particularly, said zeolite may have, in its as-synthesized and calcined forms, XRD patterns including the peaks of Tables 1 (or 1A) and 2 (or 2A) respectively, wherein the d-spacing values have a deviation determined based on the corresponding deviation±0.20 degree 2-theta when converted to the corresponding values for d-spacing using Bragg's law.

TABLE 1

| Degree 2-theta | Relative Intensity |
|---|---|
| (±0.20) | [100 × I/(Io)] |
| 7.48 | 29.7 |
| 7.92 | 85.3 |
| 8.23 | 29.5 |
| 11.13 | 16.9 |
| 11.54 | 17.4 |
| 11.85 | 29 |
| 14.96 | 33.6 |
| 19.60 | 60.4 |
| 19.96 | 27.4 |
| 20.46 | 31.8 |
| 21.15 | 19.7 |
| 22.31 | 14.8 |
| 23.16 | 100 |
| 24.39 | 42.9 |
| 24.82 | 50.3 |
| 26.51 | 72 |
| 27.03 | 41.3 |
| 27.98 | 19 |
| 31.18 | 11.1 |
| 34.23 | 13.6 |

TABLE 1A

| Degree 2-theta | d-spacing | Relative Intensity |
|---|---|---|
| (±0.20) | (Å) | [100 × I/(Io)] |
| 7.48 | 11.81 | 29.7 |
| 7.92 | 11.16 | 85.3 |
| 8.23 | 10.73 | 29.5 |
| 11.13 | 7.95 | 16.9 |
| 11.54 | 7.66 | 17.4 |
| 11.85 | 7.46 | 29 |
| 14.96 | 5.92 | 33.6 |
| 19.60 | 4.53 | 60.4 |
| 19.96 | 4.45 | 27.4 |
| 20.46 | 4.34 | 31.8 |
| 21.15 | 4.20 | 19.7 |
| 22.31 | 3.98 | 14.8 |
| 23.16 | 3.84 | 100 |
| 24.39 | 3.65 | 42.9 |
| 24.82 | 3.58 | 50.3 |
| 26.51 | 3.36 | 72 |
| 27.03 | 3.30 | 41.3 |
| 27.98 | 3.19 | 19 |
| 31.18 | 2.87 | 11.1 |
| 34.23 | 2.62 | 13.6 |

TABLE 2

| Degree 2-theta | Relative Intensity |
|---|---|
| (±0.20) | [100 × I/(Io)] |
| 7.46 | 76.4 |
| 7.87 | 80.3 |
| 8.19 | 100 |
| 8.80 | 39.2 |
| 11.10 | 10 |
| 11.54 | 12.1 |
| 13.18 | 19.6 |
| 14.92 | 30.3 |
| 19.62 | 11.1 |
| 19.97 | 34.6 |
| 20.48 | 33.9 |
| 22.33 | 12 |
| 23.19 | 83.2 |
| 24.44 | 13 |
| 24.85 | 30.3 |
| 26.54 | 76.8 |
| 31.18 | 12.5 |
| 34.30 | 10.8 |

TABLE 2A

| Degree 2-theta | d-spacing | Relative Intensity |
|---|---|---|
| (±0.20) | (Å) | [100 × I/(Io)] |
| 7.46 | 11.84 | 76.4 |
| 7.87 | 11.22 | 80.3 |
| 8.19 | 10.78 | 100 |
| 8.80 | 10.04 | 39.2 |
| 11.10 | 7.96 | 10 |
| 11.54 | 7.66 | 12.1 |
| 13.18 | 6.71 | 19.6 |
| 14.92 | 5.93 | 30.3 |
| 19.62 | 4.52 | 11.1 |
| 19.97 | 4.44 | 34.6 |
| 20.48 | 4.33 | 33.9 |
| 22.33 | 3.98 | 12 |
| 23.19 | 3.83 | 83.2 |
| 24.44 | 3.64 | 13 |
| 24.85 | 3.58 | 30.3 |
| 26.54 | 3.36 | 76.8 |
| 31.18 | 2.87 | 12.5 |
| 34.30 | 2.61 | 10.8 |

The XRD patterns with the XRD peaks described herein use Cu(K_{α}) radiation.

The zeolite of the present disclosure, where part or all of the SDA has been removed, may be used as an adsorbent or as a catalyst or support for catalyst in a wide variety of hydrocarbon conversions, e.g., conversion of organic compounds to a converted product. In a fifth aspect, the present disclosure therefore relates to a process of converting an organic compound to a conversion product, which comprises contacting the organic compound with the zeolite of the present disclosure or prepared according to the process the present disclosure.

The zeolite of the present disclosure (where part or all of the SDA is removed) may be used as an adsorbent, such as for separating at least one component from a mixture of components in the vapor or liquid phase having differential sorption characteristics with respect to the material. Therefore, at least one component can be partially or substantially totally separated from a mixture of components having differential sorption characteristics with respect to the zeolite by contacting the mixture with said zeolite to selectively sorb the one component. For instance, in a process for selectively separating one or more desired components of a feedstock from remaining components of the feedstock, the feedstock may be contacted with a sorbent that comprises the zeolite of the present disclosure at effective sorption conditions, thereby forming a sorbed product and an effluent product. One or more of the desired components are recovered from either the sorbed product or the effluent product.

The zeolite of the present disclosure (where part or all of the SDA is removed) may also be used as a catalyst to catalyze a wide variety of organic compound conversion processes. Examples of chemical conversion processes, which are effectively catalyzed by the zeolite described herein, either alone or in combination with one or more other catalytically active substances including other crystalline catalysts, include those requiring a catalyst with acid activity. Examples of organic conversion processes, which may be catalyzed by the zeolite described herein, either alone or in combination with one or more other catalytically active substances, including other crystalline catalysts, include cracking, hydrocracking, isomerization, polymerisation, reforming, hydrogenation, dehydrogenation, dewaxing, hydrodewaxing, adsorption, alkylation, transalkylation, dealkylation, hydrodecylization, disproportionation, oligomerization, dehydrocyclization, conversion of methanol to olefins, deNOx applications, and combinations thereof. The conversion of hydrocarbon feeds can take place in any convenient mode, for example in fluidized bed, moving bed, or fixed bed reactors depending on the types of process desired.

The zeolite of the present disclosure may be formulated into product compositions by combination with other materials, such as binders and/or matrix materials that provide additional hardness to the finished product. These other materials can be inert or catalytically active materials.

For instance, it may be desirable to incorporate the zeolite of the present disclosure with another material that is resistant to the temperatures and other conditions employed during use. Such materials include synthetic or naturally occurring zeolites as well as inorganic materials such as clays, silica and/or metal oxides such as alumina and mixtures thereof. The metal oxides may be either naturally occurring or in the form of gelatinous precipitates or gels including mixtures of silica and metal oxides. Use of a resistant material in conjunction with the zeolite of the present disclosure, i.e., combined therewith or present during synthesis of the as-made zeolite, which crystal is active, tends to change the conversion and/or selectivity of the catalyst in certain organic conversion processes. Inactive resistant materials suitably serve as diluents to control the amount of conversion in a given process so that products can be obtained in an economic and orderly manner without employing other means for controlling the rate of reaction. These materials may be incorporated into naturally occurring clays, e.g., bentonite and kaolin, to improve the crush strength of the product under commercial operating conditions. Said inactive resistant materials, i.e., clays, oxides, etc., function as binders for the catalyst. A catalyst having good crush strength can be beneficial because in commercial use, it is desirable to prevent the catalyst from breaking down into powder-like materials.

Naturally occurring clays which may be used include the montmorillonite and kaolin family, which families include the subbentonites, and the kaolins commonly known as Dixie, McNamee, Georgia and Florida clays or others in which the main mineral constituent is halloysite, kaolinite, dickite, nacrite, or anauxite. Such clays can be used in the raw state as originally mined or after being subjected to calcination, acid treatment or chemical modification. Binders useful for compositing with the zeolite of the present disclosure also include inorganic oxides selected from silica, zirconia, titania, magnesia, beryllia, alumina, yttria, gallium oxide, zinc oxide and mixtures thereof.

In addition to the foregoing materials, the zeolite of the present disclosure may be composited with a porous matrix material such as silica-alumina, silica-magnesia, silica-zirconia, silica-thoria, silica-beryllia, silica-titania as well as ternary compositions such as silica-alumina-thoria, silica-alumina-zirconia, silica-alumina-magnesia and silica-magnesia-zirconia.

These binder materials are resistant to the temperatures and other conditions, e.g., mechanical attrition, which occur in various hydrocarbon separation processes. Thus the zeolite of the present disclosure may be used in the form of an extrudate with a binder. They are typically bound by forming a pill, sphere, or extrudate. The extrudate is usually formed by extruding the zeolite, optionally in the presence of a binder, and drying and calcining the resulting extrudate. Further treatments such as steaming, and/or ion exchange may be carried out as required. The zeolite may optionally be bound with a binder having a surface area of at least 100 m²/g, for instance at least 200 m²/g, optionally at least 300 m²/g.

The relative proportions of zeolite and inorganic oxide matrix may vary widely, with the zeolite content ranging from about 1 to about 100 percent by weight and more usually, particularly when the composite is prepared in the form of extrudates, in the range of about 2 to about 95, optionally from about 20 to about 90 weight percent of the composite.

The zeolite of the present disclosure may also be used in intimate combination with a hydrogenating component such as tungsten, vanadium, molybdenum, rhenium, nickel, cobalt, chromium, manganese, or a noble metal such as platinum or palladium where a hydrogenation-dehydrogenation function is to be performed. Such hydrogenating components may be incorporated in the composition by way of one or more of the following processes: cocrystallization; exchanged into the composition to the extent a Group IIIA element, e.g., aluminum, is in the structure; or intimately physically admixed therewith. Such components can also be impregnated in or onto the zeolite, for example, by treating the zeolite with a hydrogenating metal-containing ion. For instance, in the case of platinum, suitable platinum compounds for this purpose include chloroplatinic acid, platinous chloride and various compounds containing a platinum amine complex. Combinations of metals and methods for their introduction can also be used.

It will be understood by a person skilled in the art that the zeolite of the present disclosure may contain impurities, such as amorphous materials, unit cells having different topologies (e.g., quartz, zeolites or molecular sieves of different framework type, that may or may not impact the performance of the resulting catalyst), and/or other impurities (e.g., heavy metals and/or organic hydrocarbons). Typical examples of zeolites or molecular sieves of different framework type co-existing with the zeolite of the present disclosure are e.g., zeolites or molecular sieves of SFS, MFI, MEL, MTW or TON framework type, such as SSZ-56, ZSM-5, ZSM-11, ZSM-12, or ZSM-22. The zeolite of the present disclosure is preferably substantially free of impurities. The term “substantially free of impurities” (or in the alternative “substantially pure”) used herein means the zeolite material contains a minor proportion (less than 50 wt %), preferably less than 20 wt %, more preferably less than 10 wt %, even more preferably less than 5 wt % and most preferably less than 1 wt % (e.g., less than 0.5 wt % or 0.1 wt %), of such impurities (or “non-BOG” framework type), which weight percent (wt %) values are based on the combined weight of impurities and pure zeolite. The amount of impurities can be appropriately determined by powder XRD, rotating electron diffraction, and/or SEM/TEM (e.g., different crystal morphologies).

The zeolite described herein is substantially crystalline. As used herein, the term “crystalline” refers to a crystalline solid form of a material, including, but not limited to, a single-component or multiple-component crystal form, e.g., including solvates, hydrates, and a co-crystal. Crystalline can mean having a regularly repeating and/or ordered arrangement of molecules, and possessing a distinguishable crystal lattice. For example, the zeolite can have different water or solvent content. The different crystalline lattices can be identified by solid state characterization methods such as by XRD (e.g., powder XRD). Other characterization methods known to a person of ordinary skill in the relevant art can further help identify the crystalline form as well as help determine stability and solvent/water content. As used herein, the term “substantially crystalline” means a majority (greater than 50 wt %) of the weight of a sample of a material described is crystalline and the remainder of the sample is a non-crystalline form. In one or more aspects, a substantially crystalline sample has at least 95% crystallinity (e.g., 5% of the non-crystalline form), at least 96% crystallinity (e.g., 4% of the non-crystalline form), at least 97% crystallinity (e.g., 3% of the non-crystalline form), at least 98% crystallinity (e.g., about 2% of the non-crystalline form), at least 99% crystallinity (e.g., 1% of the non-crystalline form), and 100% crystallinity (e.g., 0% of the non-crystalline form).

Aspects of the disclosure are described in greater detail by way of specific examples. The following examples are offered for illustrative purposes and are not intended to limit the disclosure in any manner. Those of skill in the relevant art will readily recognize a variety of parameters can be changed or modified to yield essentially the same results.

### EXAMPLES

The present invention is further illustrated below without limiting the scope thereto.

In these examples, the X-ray diffraction (XRD) patterns of the as-synthesized and calcined materials were recorded on an X-Ray Powder Diffractometer (Bruker DaVinci D8 Discovery instrument) in continuous mode using a Cu Kα radiation, Bragg-Bentano geometry with Vantec 500 detector, in the 2θ range of 4 to 36 degrees. The interplanar spacings, d-spacings, were calculated in Angstrom units, and the relative intensities of the lines, I/Iₒ is the ratio of the peak intensity to that of the intensity of the strongest line, above background. The intensities are uncorrected for Lorentz and polarization effects. The location of the diffraction peaks in 2-theta, and the relative peak area intensities of the lines, I/I(o), where Io is the intensity of the strongest line, above background, were determined with the MDI Jade peak search algorithm. It should be understood that diffraction data listed as single lines may consist of multiple overlapping lines which under certain conditions, such as differences in crystallographic changes, may appear as resolved or partially resolved lines. Typically, crystallographic changes can include minor changes in unit cell parameters and/or a change in crystal symmetry, without a change in the framework connectivity. These minor effects, including changes in relative intensities, can also occur as a result of differences in cation content, framework composition, nature and degree of pore filling, crystal size and shape, preferred orientation and thermal and/or hydrothermal history.

The scanning electron microscopy (SEM) images of the as-synthesized materials were obtained on a Hitachi 4800 Scanning Electron Microscope. SEM images were used to aid assessment of product purity. The presence of obviously different crystal morphologies in a SEM image can be an indication of impurities in the form of other crystalline materials. Such an approximate analysis can be especially useful in identifying the presence of formation of relatively minor amounts of crystalline impurities which may not be identifiable on product XRD patterns.

The following measurements were conducted on samples that were calcined at 600° C. in air within a box furnace for 8 hours.

The overall BET surface area (S_{BET}) of the materials was determined by the BET method as described by S. Brunauer, P. H. Emmett and E. Teller, J. Am. Chem. Soc., 1938, 60, 309, incorporated herein by reference, using nitrogen adsorption-desorption at liquid nitrogen temperature. The external surface area (Sₑₓₜ) of the material was obtained from the t-plot method, and the micropore surface area (S_{micro}) of the material was calculated by subtracting the external surface area (Sₑₓₜ) from the overall BET surface area (S_{BET}).

The micropore volume (V_{micro}) of the materials can be determined using methods known in the relevant art. For example, the micropore volume of the materials can be measured with nitrogen physisorption, and the data can be analyzed by the t-plot method described in Lippens, B. C. et al., “Studies on pore system in catalysts: V. The t method”, J. Catal., 4, 319 (1965), which describes micropore and total pore volume methods and is incorporated herein by reference.

The molar ratios and conditions used for the syntheses of Examples 2 to 13, as well as the resulting products, are detailed below and summarized in Table 3.

### Example 1A: Synthesis of 1,5-diethyl-5-azaindolium cation (SDA1)

25 g (221.6 mmol) of 5-azaindole (1H-pyrrolo[3,2-c]pyridine), 75.9 g (486.7 mmol) of iodoethane, and 13.06 g (232.8 mmol) of potassium hydroxide in 400 mL of acetonitrile were heated to 80° C. for 6 hours. The acetonitrile was removed via rotovap and the residue dissolved in 250 mL of chloroform. The potassium salts were removed by filtration and the chloroform removed via rotovap. ¹H-NMR showed that the brown solid was 1,5-diethyl-5-azaindolium (1,5-diethyl-1H-pyrrolo[3,2-c]pyridin-5-ium) iodide.

The iodide salt was ion-exchanged with ion-exchange resin Amberlite® IRN78 OH hydroxide form, with a iodide:resin:water weight ratio of 1:3.5:5, to its hydroxide form. The exchange was performed at room temperature overnight.

### Example 1B: Synthesis of 5-ethyl-1-propyl-5-azaindolium cation (SDA2)

A solution of 29.7 g potassium hydroxide (85% wt), 50 g of 5-azaindole (1H-pyrrolo[3,2-c]pyridine), and 550 mL of acetonitrile was mixed and stirred for a few hours. Then, 63 g propyl iodide was added dropwise, and the reaction was stirred for 16 hours at room temperature. The solids were filtered and the acetonitrile rotovapped off. The residue was dissolved in 500 mL of ethyl acetate and the organics washed 3 times with 250 mL of water. The organics were dried over magnesium sulfate and removed via rotovap to give 1-propyl-5-azaindole (1-propyl-1H-pyrrolo[3,2-c]pyridine).

25 g of 1-propyl-5-azaindole were dissolved in 200 mL of acetonitrile, then 36 g of iodoethane were added and the mixture was gently refluxed for 16 hours. The acetonitrile was removed via rotovap to obtain 5-ethyl-1-propyl-5-azaindolium iodide (5-ethyl-1-propyl-1H-pyrrolo[3,2-c]pyridin-5-ium iodide).

The iodide salt was ion-exchanged with ion-exchange resin Amberlite® IRN78 OH hydroxide form, with a iodide:resin:water weight ratio of 1:4:5, to its hydroxide form. The exchange was performed at room temperature overnight.

### Example 1C: Synthesis of 5-methyl-1-propyl-5-azaindolium cation (SDA3)

5-methyl-1-propyl-5-azaindolium cation (or 5-methyl-1-propyl-1H-pyrrolo[3,2-c]pyridin-5-ium hydroxide) was synthesized in conditions similar to Example 1B for the synthesis of 5-ethyl-1-propyl-5-azaindolium cation (SDA2), except that iodoethane was replaced with iodomethane as alkylating agent.

### Example 1D: Synthesis of 1-ethyl-5-isopropyl-5-azaindolium cation (SDA4)

1-ethyl-5-isopropyl-5-azaindolium hydroxide (or 1-ethyl-5-isopropyl-1H-pyrrolo[3,2-c]pyridin-5-ium hydroxide) was synthesized in conditions similar to Example 1B for the synthesis of 5-ethyl-1-propyl-5-azaindolium cation (SDA2), except that propyl iodide was replaced with iodoethane in the first step and iodoethane was replaced with isopropyl iodide in the second step.

### Example 2: Synthesis in Hydroxide Media, SDA1, Si/Al=15

In a PTFE liner for a 45 mL Steel Parr autoclave, the following were mixed together: 20.6 g of 1,5-diethyl-5-azaindolium cation (Q) as structure directing agent (hydroxide form, 7.2 wt % solution), 2.16 g of KOH solution (20 wt %), and 3.7 g of Ultrastable Y (USY) zeolite with a Si/Al molar ratio of 15 (available from Zeolyst as CBV720) to produce a synthesis mixture having the following composition in terms of molar ratios:

30 H₂O: 1 SiO₂: 0.033 Al₂O₃: 0.15 QOH: 0.15 KOH

The liner was then capped, sealed within a 45 mL Parr autoclave, and placed within a spit inside of a convection over. The reactor was heated at 160° C. for 10 days under tumbling conditions (about 30 rpm). The product was isolated by filtration, rinsed with deionized water and dried. The as-synthesized material was then calcined to 600° C. in air within a box furnace with a ramping rate of 3° C./minute. The temperature remained at 600° C. for 8 hours and then the box furnace was allowed to cool.

FIG. 1 shows the powder XRD pattern and Table 4 the list of peaks and intensities of the as-synthesized material of Example 2. FIG. 2 shows the powder XRD pattern and Table 5 the list of peaks and intensities of the calcined material of Example 2. XRD analysis of the as-synthesized and calcined versions of the product showed the material to have similar powder XRD patterns to ITQ-47 in terms of degree 2-theta, d-spacing and relative intensities (as illustrated in FIG. 1 of Huang et al., which is incorporated herein by reference in its entirety), the material of Example 2 being an aluminosilicate zeolite of BOG framework type.

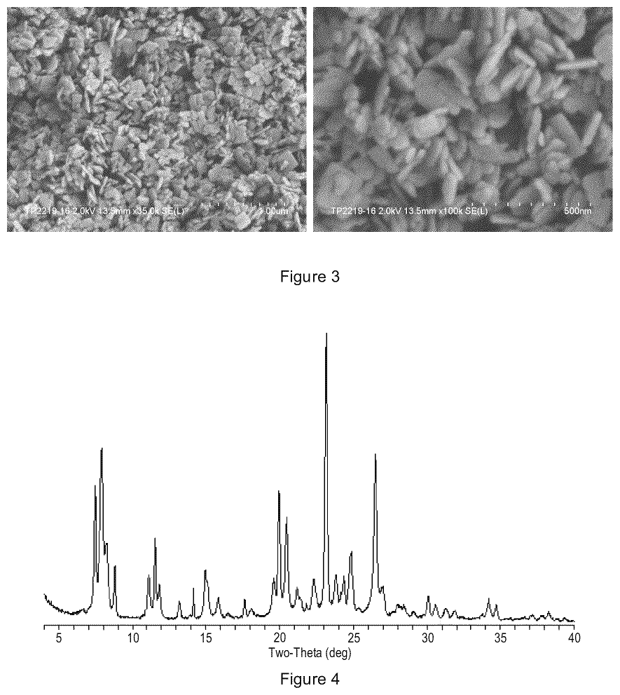

The material of Example 2 however differed from ITQ-47 at least by its particle size and morphology, as illustrated by FIG. 3 which shows SEM images of the as-synthesized product. More particularly, the material of Example 2 was shown to have a unique plate-like morphology with an average maximal particle size of less than 1 micron (i.e., about 100-200 nm), corresponding to the average long particle diffusion length. This new product was identified as EMM-76.

ICP analysis indicated the product had a Si/Al molar ratio of 14.

N₂ measurements of the calcined zeolite resulted in a total BET surface area of 715 m²/g, with a micropore surface area of 652 m²/g and external surface area of 63 m²/g. The t-plot method gave a micropore volume of 0.25 cm³/g.

The adsorption uptake for n-hexane, 2,2-dimethylbutane (2,2-DMB), 2,3-dimethylbutane (2,3-DMB), and mesitylene were determined on ion-exchanged and calcined materials. The material was placed under a nitrogen stream then the hydrocarbon was introduced through a sparger to saturate the nitrogen stream and the hydrocarbon uptake was determined. Each hydrocarbon was adsorbed at a different temperature: n-hexane was adsorbed at 90° C., 2,2-DMB was adsorbed at 120° C., 2,3-DMB was adsorbed at 120° C., and mesitylene was adsorbed at 100° C. n-hexane uptake was 126 mg/g, 2,2-DMB uptake was 141 mg/g, 2,3-DMB uptake was 125 mg/g, and mesitylene uptake was 109 mg/g. These data demonstrate that much of the micropore volume in EMM-76 is available to these adsorbate molecules. The 12MR pore channels are evidently large enough to accommodate mesitylene (1,3,5-trimethylbenzene), leading to similar capacity of the smaller absorbates.

### Example 3: Scale-Up Synthesis in Hydroxide Media, SDA1, Si/Al=15

In a 2 L stainless steel, over-head stirred autoclave, the following were mixed together: 711.2 g of 1,5-diethyl-5-azaindolium cation (Q) as structure directing agent (hydroxide form, 10.4 wt % solution), 217.6 g of Ultrastable Y (USY) zeolite with a Si/Al molar ratio of 15 (available from Zeolyst as CBV720), 122.5 g of KOH solution (20 wt %) and 449 g of deionized water, producing a synthesis mixture having the following composition in terms of molar ratios:

23 H₂O: 1 SiO₂: 0.033 Al₂O₃: 0.15 QOH: 0.15 KOH

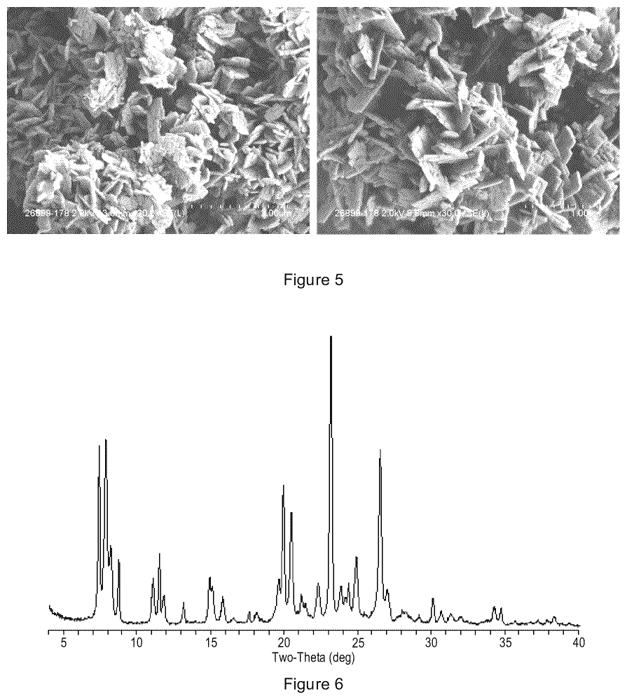

The Parr autoclave was sealed and placed in an overhead stirring mechanism within a heating mantle. After 7 days at 170° C. under stirring conditions (about 180 rpm), the product was isolated by centrifugation, rinsed twice with deionized water, and dried at 100° C. XRD analysis of the as-synthesized product, illustrated in FIG. 4, showed the material to be EMM-76. SEM images of the as-synthesized product, illustrated in FIG. 5, indicated the EMM-76 crystals to have an average maximal particle size of less than 1 micron (i.e., about 50 to 200 nm) with a unique aggregated plate-like morphology.

### Example 4: Synthesis in Hydroxide Media, SDA1, Si/Al=15

This example was conducted in the same conditions as Example 2 except that KOH was replaced by NaOH to produce a synthesis mixture having the following composition in terms of molar ratios:

30 H₂O: 1 SiO₂: 0.033 Al₂O₃: 0.15 QOH: 0.15 NaOH

After 7 days of heating at 160° C., EMM-76 material was obtained together with a small amount of EMM-73 material, as identified by its XRD pattern and SEM micrographs.

### Example 5: Synthesis in Hydroxide Media, SDA1, Si/Al=15

This example was conducted in the same conditions as Example 2 except that KOH was replaced by CsOH to produce a synthesis mixture having the following composition in terms of molar ratios:

30 H₂O: 1 SiO₂: 0.033 Al₂O₃: 0.15 QOH: 0.15 CsOH

After 8 days of heating at 160° C., EMM-76 material was obtained together with a small amount of EMM-73 material, as identified by its XRD pattern and SEM micrographs.

### Example 6: Synthesis in Hydroxide Media, SDA1, Si/Al=15

This example was conducted in the same conditions as Example 2 except for a lower amount of SDA1, a lower amount of water and the presence of about 1-2 wt % EMM-76 seeds to produce a synthesis mixture having the following composition in terms of molar ratios:

16 H₂O: 1 SiO₂: 0.033 Al₂O₃: 0.1 QOH: 0.15 KOH

After 10 days of heating at 160° C., pure EMM-76 material was obtained, as identified by its XRD pattern and SEM micrographs.

### Example 7: Synthesis in Hydroxide Media, SDA1, Si/Al=8

In a PTFE liner for a 23 mL Steel Parr autoclave, the following were mixed together: 3.84 g of 1,5-diethyl-5-azaindolium cation (Q) as structure directing agent (hydroxide form, 7.2 wt % solution), 0.4 g of KOH solution (20 wt %), 0.5 g of Ultrastable Y (USY) zeolite with a Si/Al molar ratio of 6 (available from Zeolyst as CBV712), and 0.17 g of Ultrastable Y (USY) zeolite with a Si/Al molar ratio of 15 (available from Zeolyst as CBV720), in the presence of 0.01 g of EMM-76 seeds, to produce a synthesis mixture having the following composition in terms of molar ratios:

23 H₂O: 1 SiO₂: 0.061 Al₂O₃: 0.15 QOH: 0.15 KOH

The liner was then capped, sealed within a 23 mL Parr autoclave, and placed within a spit inside of a convection over. The reactor was heated at 160° C. for 9 days under tumbling conditions (about 30 rpm). The product was isolated by filtration, rinsed with deionized water and dried, and identified as pure EMM-76, based on its XRD pattern and SEM micrographs.

### Example 8: Synthesis in Hydroxide Media, SDA2, Si/Al=15

In a PTFE liner for a 125 mL Steel Parr autoclave, the following were mixed together: 17.0 g of 5-ethyl-1-propyl-5-azaindolium cation (Q) as structure directing agent (hydroxide form, 20.5 wt % solution), 6.3 g of KOH solution (20 wt %), 8.0 g of Ultrastable Y (USY) zeolite with a Si/Al molar ratio of 15 (available from Zeolyst as CBV720), and 41.6 g of deionized water, in the presence of 0.1 g of EMM-76 seeds, to produce a synthesis mixture having the following composition in terms of molar ratios:

30 H₂O: 1 SiO₂: 0.033 Al₂O₃: 0.15 QOH: 0.2 KOH

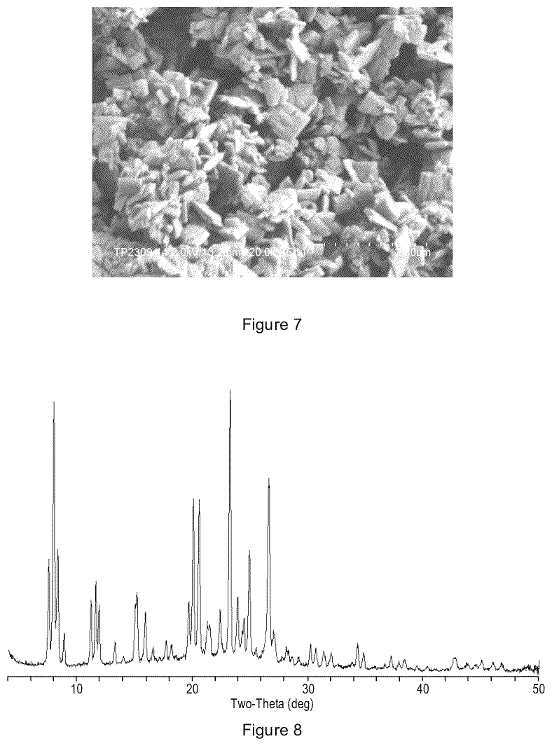

The liner was then capped, sealed within a 125 mL Parr autoclave, and placed within a spit inside of a convection over. The reactor was heated at 160° C. for 14 days under tumbling conditions (about 30 rpm). The product was isolated by filtration, rinsed with deionized water, dried, and identified as pure EMM-76, based on its XRD pattern (FIG. 6) and SEM micrographs (FIG. 7). The product was shown to have a plate-like morphology with an average maximal particle size of less than 1 micron (i.e., about 50 to 500 nm).

N₂ measurements of the calcined zeolite resulted in a total BET surface area of 715 m²/g, with a micropore surface area of 694 m²/g and external surface area of 21 m²/g. The t-plot method gave a micropore volume of 0.26 cm³/g.

### Example 9: Synthesis in Hydroxide Media, SDA3, Si/Al=15

In a PTFE liner for a 23 mL Steel Parr autoclave, the following were mixed together: 1.61 g of 5-methyl-1-propyl-5-azaindolium cation (Q) as structure directing agent (hydroxide form, 13.5 wt % solution), 0.45 g of NaOH solution (10 wt %), 0.54 g of Ultrastable Y (USY) zeolite with a Si/Al molar ratio of 15 (available from Zeolyst as CBV720), and 2.21 g of deionized water to produce a synthesis mixture having the following composition in terms of molar ratios:

30 H₂O: 1 SiO₂: 0.033 Al₂O₃: 0.15 QOH: 0.15 NaOH

The liner was then capped, sealed within a 23 mL Parr autoclave, and placed within a spit inside of a convection over. The reactor was heated at 160° C. for 20 days under tumbling conditions (about 30 rpm). The product was isolated by filtration, rinsed with deionized water and dried. The as-synthesized material was identified as pure EMM-76, based on its XRD pattern and SEM micrographs.

### Example 10: Synthesis in Hydroxide Media, SDA4, Si/Al=15

In a PTFE liner for a 23 mL Steel Parr autoclave, the following were mixed together: 2.8 g of 1-ethyl-5-isopropyl-5-azaindolium cation (Q) as structure directing agent (hydroxide form, 8 wt % solution), 0.41 g of KOH solution (20 wt %), 0.52 g of Ultrastable Y (USY) zeolite with a Si/Al molar ratio of 15 (available from Zeolyst as CBV720), and 1 g of deionized water to produce a synthesis mixture having the following composition in terms of molar ratios:

30 H₂O: 1 SiO₂: 0.033 Al₂O₃: 0.15 QOH: 0.2 KOH

The liner was then capped, sealed within a 23 mL Parr autoclave, and placed within a spit inside of a convection over. The reactor was heated at 160° C. for 20 days under tumbling conditions (about 30 rpm). The product was isolated by filtration, rinsed with deionized water, dried, and identified as pure EMM-76, based on its XRD pattern.

### Example 11: Synthesis in Fluoride Media, SDA1, Si/Al=12.5

1.26 g of tetraethylorthosilicate (TEOS, >99 wt %) and 0.0456 g of aluminum hydroxide (Al(OH)₃, Sigma, 54 wt % Al₂O₃) were hydrolyzed at room temperature in 8.1 g of 1,5-diethyl-5-azaindolium cation (Q) (hydroxide form, 7.2 wt % solution) for about 2-3 hours. The mixture was then heated at about 50° C. to remove the ethanol and water. 0.13 g HF (48 wt % solution) were added to the mixture to produce a synthesis mixture having the following composition in terms of molar ratios:

5 H₂O: 1 SiO₂: 0.04 Al₂O₃: 0.5 QOH: 0.5 HF

The resulting thick paste was homogenized by hand in a Teflon® container and transferred to a 10 mL Teflon-lined stainless steel Parr autoclave. The autoclave was heated to 160° C. for 14 days in a tumbling oven (about 40 rpm). After 14 days, the reactor was discharged and the product was collected using centrifugation and washing three times with distilled water (100 mL). The product was dried at 90° C. in a vented drying oven.

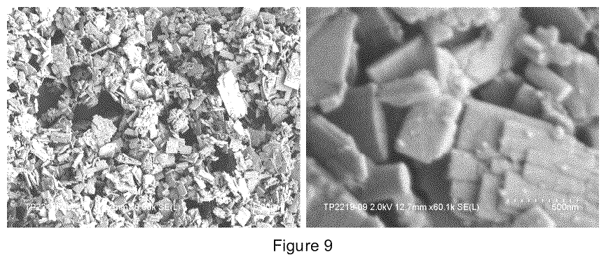

The product was identified as pure EMM-76 material on the basis of its XRD pattern, shown in FIG. 8, and SEM micrographs, shown in FIG. 9.

### Example 12: Synthesis in Fluoride Media, SDA1, Si/Al=33.3

This example was conducted in similar conditions as Example 11 except that the synthesis mixture contained a lower amount of aluminum hydroxide, to produce a synthesis mixture having the following composition in terms of molar ratios:

5 H₂O: 1 SiO₂: 0.015 Al₂O₃: 0.5 QOH: 0.5 HF

After 14 days of heating at 160° C., pure EMM-76 material was obtained, as identified by its XRD pattern and SEM micrographs.

### Example 13: Synthesis in Fluoride Media, SDA2, Si/Al=15

This example was conducted in similar conditions as Example 11 except that 5-ethyl-1-propyl-5-azaindolium cation (Q) was used as structure directing agent (hydroxide form, 20.5 wt % solution) with a slightly lower amount of aluminum hydroxide, to produce a synthesis mixture having the following composition in terms of molar ratios:

5 H₂O: 1 SiO₂: 0.033 Al₂O₃: 0.5 QOH: 0.5 HF

After 28 days of heating at 160° C., EMM-76 material was obtained together with a small amount of EMM-73 material, as identified by its XRD pattern and SEM micrographs.

### Example 14: Synthesis in Fluoride Media, SDA2, Si/Al=15

This example was conducted in similar conditions as Example 13 except for higher amounts of water and HF and the presence of KOH, to produce a synthesis mixture having the following composition in terms of molar ratios:

16 H₂O: 1 SiO₂: 0.033 Al₂O₃: 0.5 QOH: 0.15 KOH: 1.0 HF

After 28 days of heating at 160° C. EMM-76 material was obtained together with a small amount of EMM-73 material, as identified by its XRD pattern and SEM micrographs.

TABLE 3

| | Si | Al | | | | | | | | T | t | |
|---|---|---|---|---|---|---|---|---|---|---|---|---|
| Ex. | Source | Source | SDA* | Si/Al | H₂O/Si | Q/Si | OH/Si | M/Si | F/Si | (° C.) | (days) | Product |
| 2 | USY | USY | SDA1 | 15 | 30 | 0.15 | 0.3 | 0.15 (K) | 0 | 160 | 10 | EMM-76 |
| | (Si/Al = 15) | (Si/Al = 15) | | | | | | | | | | |
| 3 | USY | USY | SDA1 | 15 | 23 | 0.15 | 0.3 | 0.15 (K) | 0 | 170 | 7 | EMM-76 |
| | (Si/Al = 15) | (Si/Al = 15) | | | | | | | | | | |
| 4 | USY | USY | SDA1 | 15 | 30 | 0.15 | 0.3 | 0.15 (Na) | 0 | 160 | 7 | EMM-76 |
| | (Si/Al = 15) | (Si/Al = 15) | | | | | | | | | | [EMM-73] |
| 5 | USY | USY | SDA1 | 15 | 30 | 0.15 | 0.3 | 0.15 (Cs) | 0 | 160 | 8 | EMM-76 |
| | (Si/Al = 15) | (Si/Al = 15) | | | | | | | | | | [EMM-73] |
| 6 | USY | USY | SDA1 | 15 | 16 | 0.1 | 0.25 | 0.15 (K) | 0 | 170 | 10 | EMM-76 |
| | (Si/Al = 15) | (Si/Al = 15) | | | | | | | | | | |
| 7 | USY | USY | SDA1 | 8 | 23 | 0.15 | 0.3 | 0.15 (K) | 0 | 160 | 9 | EMM-76 |
| | (Si/Al = 15&6) | (Si/Al = 15&6) | | | | | | | | | | |
| 8 | USY | USY | SDA2 | 15 | 30 | 0.15 | 0.35 | 0.2 (K) | 0 | 160 | 14 | EMM-76 |
| | (Si/Al = 15) | (Si/Al = 15) | | | | | | | | | | |
| 9 | USY | USY | SDA3 | 15 | 30 | 0.15 | 0.3 | 0.15 (Na) | 0 | 160 | 20 | EMM-76 |
| | (Si/Al = 15) | (Si/Al = 15) | | | | | | | | | | |
| 10 | USY | USY | SDA4 | 15 | 30 | 0.15 | 0.35 | 0.2 (K) | 0 | 160 | 20 | EMM-76 |
| | (Si/Al = 15) | (Si/Al = 15) | | | | | | | | | | |
| 11 | TEOS | Al(OH)₃ | SDA1 | 12.5 | 5 | 0.5 | 0.5 | 0 | 0.5 | 160 | 21 | EMM-76 |
| 12 | TEOS | Al(OH)₃ | SDA1 | 33.3 | 5 | 0.5 | 0.5 | 0 | 0.5 | 160 | 14 | EMM-76 |
| 13 | TEOS | Al(OH)₃ | SDA2 | 15 | 5 | 0.5 | 0.5 | 0 | 0.5 | 160 | 28 | EMM-76 |
| | | | | | | | | | | | | [EMM-73] |
| 14 | TEOS | Al(OH)₃ | SDA2 | 15 | 16 | 0.5 | 0.65 | 0.15 (K) | 1.0 | 160 | 28 | EMM-76 |
| | | | | | | | | | | | | [EMM-73] |

*SDA1 = 1,5-diethyl-5-azaindolium cation; SDA2 = 5-ethyl-1-propyl-5-azaindolium cation; SDA3 = 5-methyl-1-propyl-5-azaindolium cation; SDA4 = 1-ethyl-5-isopropyl-5-azaindolium cation.

TABLE 4

| Degree 2-theta | d-spacing | Relative Intensity |
|---|---|---|
| (±0.20) | (Å) | [100 × I/(Io)] |
| 7.48 | 11.81 | 29.7 |
| 7.92 | 11.16 | 85.3 |
| 8.23 | 10.73 | 29.5 |
| 8.80 | 10.04 | 8.6 |
| 11.13 | 7.95 | 16.9 |
| 11.54 | 7.66 | 17.4 |
| 11.85 | 7.46 | 29 |
| 13.16 | 6.72 | 8.5 |
| 14.96 | 5.92 | 33.6 |
| 15.82 | 5.60 | 9.1 |
| 16.47 | 5.38 | 3.8 |
| 17.62 | 5.03 | 5.6 |
| 18.09 | 4.90 | 2.7 |
| 19.60 | 4.53 | 60.4 |
| 19.96 | 4.45 | 27.4 |
| 20.46 | 4.34 | 31.8 |
| 21.15 | 4.20 | 19.7 |
| 22.31 | 3.98 | 14.8 |
| 23.16 | 3.84 | 100 |
| 24.39 | 3.65 | 42.9 |
| 24.82 | 3.58 | 50.3 |
| 26.51 | 3.36 | 72 |
| 27.03 | 3.30 | 41.3 |
| 27.98 | 3.19 | 19 |
| 30.10 | 2.97 | 7.2 |
| 30.57 | 2.92 | 7.8 |
| 31.18 | 2.87 | 11.1 |
| 31.71 | 2.82 | 3.7 |
| 34.23 | 2.62 | 13.6 |
| 34.68 | 2.58 | 7.8 |

TABLE 5

| Degree 2-theta | d-spacing | Relative Intensity |
|---|---|---|
| (±0.20) | (Å) | [100 × I/(Io)] |
| 7.46 | 11.84 | 76.4 |
| 7.87 | 11.22 | 80.3 |
| 8.19 | 10.78 | 100 |
| 8.80 | 10.04 | 39.2 |
| 11.10 | 7.96 | 10 |
| 11.54 | 7.66 | 12.1 |
| 11.79 | 7.50 | 4.4 |
| 13.18 | 6.71 | 19.6 |
| 14.92 | 5.93 | 30.3 |
| 15.82 | 5.60 | 3.7 |
| 16.48 | 5.37 | 3.5 |
| 17.66 | 5.02 | 7.8 |
| 18.12 | 4.89 | 5.3 |
| 19.62 | 4.52 | 11.1 |
| 19.97 | 4.44 | 34.6 |
| 20.48 | 4.33 | 33.9 |
| 21.19 | 4.19 | 8 |
| 22.33 | 3.98 | 12 |
| 23.19 | 3.83 | 83.2 |
| 23.84 | 3.73 | 8.2 |
| 24.44 | 3.64 | 13 |
| 24.85 | 3.58 | 30.3 |
| 26.54 | 3.36 | 76.8 |
| 27.04 | 3.29 | 7.1 |
| 28.01 | 3.18 | 8.3 |
| 29.04 | 3.07 | 2.7 |
| 30.19 | 2.96 | 7.1 |
| 30.66 | 2.91 | 4.7 |
| 31.18 | 2.87 | 12.5 |
| 34.30 | 2.61 | 10.8 |
| 34.76 | 2.58 | 6.3 |

While the present invention has been described and illustrated with reference to particular embodiments, it will be appreciated by those of ordinary skill in the art that the invention lends itself to many different alterations, modifications, and variations not specifically illustrated herein. It will also be apparent to those skilled in the art that when numerical lower limits and numerical upper limits are listed herein, ranges from any lower limit to any upper limit are contemplated. Also, all numerical values within the detailed description herein are modified by “about” the indicated value, and take into account experimental error and variations that would be expected by a person having ordinary skill in the art.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

Additionally or alternately, the invention relates to:

Embodiment 1: A method of making a zeolite of BOG framework type, comprising: (a) preparing a synthesis mixture comprising water, a source of silica, a source of alumina, a structure directing agent (Q), at least one of a source of hydroxide ions (OH) or of fluoride ions (F), and optionally a source of alkali and/or alkaline earth metal element (M), wherein the structure directing agent (Q) comprises at least one 5-azaindolium cation of Formula I, Formula II, Formula III, or Formula IV:

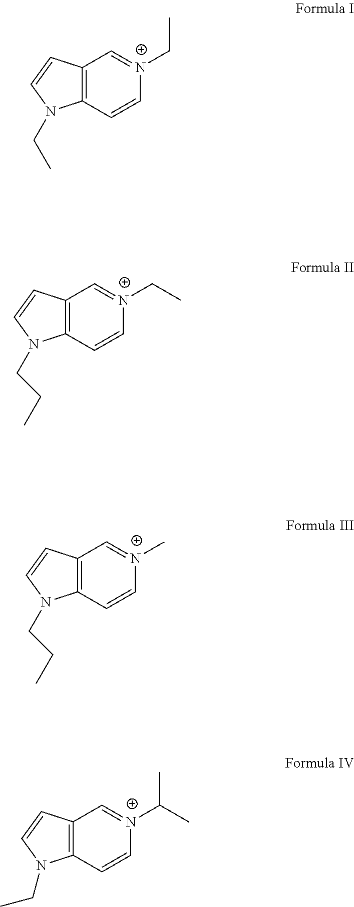

(b) heating said synthesis mixture under crystallization conditions including a temperature of from 100 to 200° C. for a time sufficient to form crystals of said molecular sieve; and (c) recovering at least a portion of the molecular sieve from step (b).

Embodiment 2: The method of embodiment 1, further comprising optionally treating the molecular sieve recovered in step (c) to remove at least part of the structure directing agent (Q).

Embodiment 3: The method of embodiment 1 or 2, wherein the structure directing agent (Q) is at least a 1,5-diethyl-5-azaindolium cation of Formula I.

Embodiment 4: The method of any one of the preceding embodiments, wherein the structure directing agent (Q) is in the form of a halide, hydroxide or nitrate, preferably wherein the structure directing agent (Q) is in its hydroxide form.

Embodiment 5: The method of any one of the preceding embodiments, wherein the synthesis mixture has the following composition in terms of molar ratios, at least one of OH/Si or F/Si being different than 0:

| Molar ratios | Typical range | Preferred range | | More preferred range | |
|---|---|---|---|---|---|
| Si/Al | 5-50 | 7-40 | | 8-35 | |
| Q/Si | 0.01-1.0 | 0.05-1.0 | | 0.1-0.8 | |
| F/Si | 0-2.0 | 0.1-1.5 | (if present) | 0.3-1.0 | (if present) |
| OH/Si | 0-1.5 | 0.1-1.0 | (if present) | 0.15-0.8 | (if present) |
| M/Si | 0-1.0 | 0.05-0.5 | (if present) | 0.08-0.2 | (if present) |

| | | | |
|---|---|---|---|
| H₂O/Si | 1-100 | 3-80 | 3-50 |

Embodiment 6: The method of any one of embodiments 1 to 4, wherein the synthesis mixture comprises at least one source of hydroxide ions.

Embodiment 7: The method of embodiment 6, wherein the synthesis mixture has the following composition in terms of molar ratios:

| Molar ratios | Typical range | Preferred range | More preferred range |
|---|---|---|---|
| Si/Al | 5-50 | 7-40 | 8-35 |
| Q/Si | 0.01-0.8 | 0.05-0.7 | 0.1-0.5 |
| OH/Si | 0.05-1.5 | 0.1-0.8 | 0.2-0.7 |
| M/Si | 0-1.0 | 0.05-0.5 | 0.1-<0.3 |
| H₂O/Si | 1-100 | 10-70 | 15-50 |

Embodiment 8: The method of embodiment 6 or 7, wherein the synthesis mixture has a F/Si molar ratio of less than 0.05, preferably less than 0.01.

Embodiment 9: The method of any one of embodiments 1 to 4, wherein the synthesis mixture comprises at least one source of fluoride ions.

Embodiment 10: The method of embodiment 9, wherein the synthesis mixture has the following composition in terms of molar ratios:

| Molar ratios | Typical range | Preferred range | More preferred range |
|---|---|---|---|
| Si/Al | 5-50 | 7-40 | 8-35 |
| Q/Si | 0.1-1.0 | 0.2-0.8 | 0.3-0.7 |
| F/Si | 0.05-2.0 | 0.15-1.5 | 0.3-1.0 |
| OH/Si | 0-1.5 | 0.05-0.8 | 0.1-0.7 |
| H₂O/Si | 1-50 | 3-30 | 3-15 |

Embodiment 11: The method of embodiment 9 or 10, wherein the synthesis mixture has a M/Si molar ratio of 0.01 to 0.5, preferably from 0 or 0.01 to 0.2, more preferably from 0 or 0.01 to 0.1, most preferably less than 0.1.

Embodiment 12: An aluminosilicate zeolite of BOG framework type having at least one 5-azaindolium cation of Formula I, of Formula II, of Formula III, or of Formula IV within its pore structure.

Embodiment 13: The zeolite of embodiment 12, obtainable by the method of any one of embodiments 1 to 11.

Embodiment 14: An aluminosilicate zeolite of BOG framework type having a Si/Al molar ratio of from 5 to 50, as determined by ICP, and an average maximal particle size of less than 2 microns, in particular of less than 1 micron, as determined by scanning electron microscopy (SEM).

Embodiment 15: The zeolite of any one of embodiments 12 to 14, wherein at least 75% of the zeolite particles (as vol %) have a maximal particle size of less than 2 microns, in particular of less than 1 micron, as determined by SEM.

Embodiment 16: The zeolite of any one of embodiments 12 to 15, wherein at least a portion of the zeolite has a plate-like morphology.

Embodiment 17: The zeolite of any one of embodiments 12 to 16, having, in its calcined form, at least one of a total BET surface area of 300 to 1000 m²/g, a micropore surface area of 300 to 1000 m²/g, an external surface area of 10 to 150 m²/g, and a micropore volume of 0.1 to 0.3 cc/g.

Embodiment 18: A process of converting an organic compound to a conversion product comprises contacting the organic compound with the molecular sieve of any one of embodiments 12 to 17.

1. A method of making a zeolite of BOG framework type, comprising:
(a) preparing a synthesis mixture comprising water, a source of silica, a source of alumina, a structure directing agent (Q), at least one of a source of hydroxide ions (OH) or of fluoride ions (F), and optionally a source of alkali and/or alkaline earth metal element (M), wherein the structure directing agent (Q) comprises at least one 5-azaindolium cation of Formula I, Formula II, Formula III, or Formula IV: 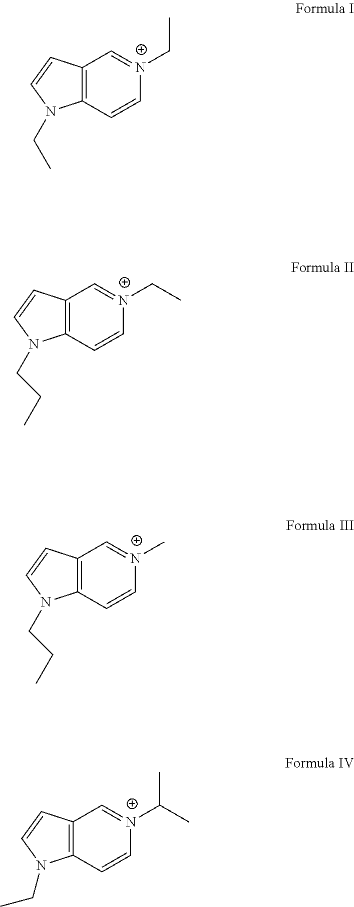
(b) heating said synthesis mixture under crystallization conditions including a temperature of from 100 to 200° C. for a time sufficient to form crystals of said molecular sieve;
(c) recovering at least a portion of the molecular sieve from step (b); and
(d) optionally treating the molecular sieve recovered in step (c) to remove at least part of the structure directing agent (Q).

2. The method of claim 1, wherein the structure directing agent (Q) is at least a 1,5-diethyl-5-azaindolium cation of Formula I.

3. The method of claim 1, wherein the structure directing agent (Q) is in the form of a halide, hydroxide or nitrate, preferably wherein the structure directing agent (Q) is in its hydroxide form.

4. The method of claim 1, wherein the synthesis mixture has the following composition in terms of molar ratios, at least one of OH/Si or F/Si being different than 0:

| Molar ratios | Typical range | Preferred range | | More preferred range | |
|---|---|---|---|---|---|
| Si/Al | 5-50 | 7-40 | | 8-35 | |
| Q/Si | 0.01-1.0 | 0.05-1.0 | | 0.1-0.8 | |
| F/Si | 0-2.0 | 0.1-1.5 | (if present) | 0.3-1.0 | (if present) |
| OH/Si | 0-1.5 | 0.1-1.0 | (if present) | 0.15-0.8 | (if present) |
| M/Si | 0-1.0 | 0.05-0.5 | (if present) | 0.08-0.2 | (if present) |
| | | | |
|---|---|---|---|
| H₂O/Si | 1-100 | 3-80 | 3-50 |

5. The method of claim 1, wherein the synthesis mixture comprises at least one source of hydroxide ions and has the following composition in terms of molar ratios:

| Molar ratios | Typical range | Preferred range | More preferred range |
|---|---|---|---|
| Si/Al | 5-50 | 7-40 | 8-35 |
| Q/Si | 0.01-0.8 | 0.05-0.7 | 0.1-0.5 |
| OH/Si | 0.05-1.5 | 0.1-0.8 | 0.2-0.7 |
| M/Si | 0-1.0 | 0.05-0.5 | 0.1-<0.3 |
| H₂O/Si | 1-100 | 10-70 | 15-50 |

6. The method of claim 5, wherein the synthesis mixture has a F/Si molar ratio of less than 0.05.

7. The method of claim 1, wherein the synthesis mixture comprises at least one source of fluoride ions and has the following composition in terms of molar ratios:

| Molar ratios | Typical range | Preferred range | More preferred range |
|---|---|---|---|
| Si/Al | 5-50 | 7-40 | 8-35 |
| Q/Si | 0.1-1.0 | 0.2-0.8 | 0.3-0.7 |
| F/Si | 0.05-2.0 | 0.15-1.5 | 0.3-1.0 |
| OH/Si | 0-1.5 | 0.05-0.8 | 0.1-0.7 |
| H₂O/Si | 1-50 | 3-30 | 3-15 |

8. The method of claim 7, wherein the synthesis mixture has a M/Si molar ratio of 0.01 to 0.5.

9. An aluminosilicate zeolite of BOG framework type having at least one 5-azaindolium cation of Formula I, of Formula II, of Formula III, or of Formula IV within its pore structure.

10. The zeolite of claim 9, wherein the aluminosilicate zeolite is made by a method comprising: comprising:
(a) preparing a synthesis mixture comprising water, a source of silica, a source of alumina, a structure directing agent (Q), at least one of a source of hydroxide ions (OH) or of fluoride ions (F), and optionally a source of alkali and/or alkaline earth metal element (M), wherein the structure directing agent (Q) comprises at least one 5-azaindolium cation of Formula I, Formula II, Formula III, or Formula IV: 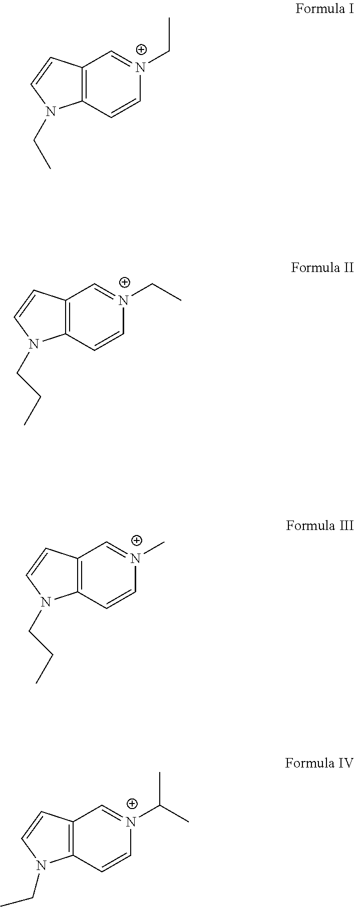
(b) heating said synthesis mixture under crystallization conditions including a temperature of from 100 to 200° C. for a time sufficient to form crystals of said molecular sieve; and
(c) recovering at least a portion of the molecular sieve from step (b).

11. The zeolite of claim 9, wherein at least 75% of the zeolite particles (as vol %) have a maximal particle size of less than 2 microns, in particular of less than 1 micron, as determined by SEM.

12. The zeolite of claim 9, wherein at least a portion of the zeolite has a plate-like morphology.

13. An aluminosilicate zeolite of BOG framework type having a Si/Al molar ratio of from 5 to 50, as determined by ICP, and an average maximal particle size of less than 2 microns, as determined by scanning electron microscopy (SEM).

14. The zeolite of claim 13, having, in its calcined form, at least one of a total BET surface area of 300 to 1000 m²/g, a micropore surface area of 300 to 1000 m²/g, an external surface area of 10 to 150 m²/g, and a micropore volume of 0.1 to 0.3 cc/g.

15. A process of converting an organic compound to a conversion product comprising contacting the organic compound with the molecular sieve of claim 13.
